(19) United States
(12) Patent Application Publication
(10) Pub. No.: US 2011/0246511 A1
(43) Pub. Date: Oct. 6, 2011

(54) METHOD AND SYSTEM FOR DEFINING AND POPULATING SEGMENTS

(76) Inventors: John Smith, Houston, TX (US); Mukesh Dalal, Portland, OR (US); Marcus Vincent, Hilo, HI (US); Greg Washburn, Oregon City, OR (US)

(21) Appl. No.: 13/081,467

(22) Filed: Apr. 6, 2011

Related U.S. Application Data
(60) Provisional application No. 61/321,417, filed on Apr. 6, 2010.

(51) Int. Cl. G06F 17/30

(52) U.S. Cl. 707/769; 707/E17.014

(57) ABSTRACT

Embodiments of the present invention provide tools and facilities for definition and population of segments to facilitate automated data analysis and automated experimentation based on user interaction with web pages, web sites, and other user interfaces, as well as for carrying out automated tasks related to users who can be partitioned into well-defined segments. Embodiments of the present invention provide a segment-definition language (“SDL”) that allows users and developers to abstractly define segments in a data-independent manner. The SDL provides many operators and constructs for creating and defining segments. SDL-based subsystem components execute SDL segment definitions to assemble segments on behalf of application programs.

### CROSS-REFERENCE TO RELATED APPLICATION

This application claims the benefit of Provisional Application No. 61/321,417, filed Apr. 6, 2010.

### TECHNICAL FIELD

The present invention is related: to automated data analysis and Internet-based experimentation and, in particular, to a method and system for defining segments of visitors who interact with computer systems to provide the raw data processed by an automated data-analysis system.

### BACKGROUND OF THE INVENTION

With the advent of the Internet and Internet-based retailing, a new web-analytics industry has emerged that provides marketing analysis and other types of analyses related to Internet-based retailing and other Internet-based activities. In one type of web-analysis system, particular web pages deployed by an Internet-based client are instrumented so that, when remote users access and interact with the deployed web pages, a web-analysis system receives information from the users' computers that allows the web-analysis system to collect a raw-data set describing user interaction with instrumented, deployed web pages. Complex, sophisticated analysis programs within the data-analysis system can then process the raw data to return results to the Internet-based client.

Much of the analytical effort carried out by a web-analysis system is based on the analysis of particular segments of users of Internet-based services.

Assuming that all of the users who interact with one or more particular instrumented, deployed web pages during a particular marketing experiment or other research endeavor constitute a set of visitors, segments represent various subsets of the set of visitors defined by various criteria, including visitor-attribute values and ranges of visitor-attribute values.

Currently, programmatic definition of segments is data-source-dependent and involves developing potentially complex database-access-language queries and/or data-access and data-processing routines. For example, the raw data collected during a data-collection phase of an instrumented-web-page-based experiment may be stored in files or one or more databases and then processed for storage in a more complex set of relational-database tables, objects, within an object-oriented database, or other type of database-management system. In order to define segments and access processed data related to segments, an analytics programmer generally needs to understand the schema and other organizational features of the database in which processed data is stored as well as the particular data-access-query language, such as the structured query language (“SQL”) used for accessing data stored in relational databases, in order to construct complex queries needed to extract data from the database relative to particular segments. Ad-hoc development of queries for defining segments and extracting data relative to segments is time consuming, costly, and extremely error prone. Analytics programmers, web-analytics-system operators and vendors, and ultimately clients and users of web-analytics-systems operators seek improved methods and systems for analyzing data input to a web-analytics system with respect to particular segments.

### SUMMARY OF THE INVENTION

Embodiments of the present invention provide tools and, facilities for definition and population of segments to facilitate automated data analysis and automated experimentation based on user interaction with web pages, web sites, and other user interfaces, as well as for carrying out automated tasks related to users who can be partitioned into well-defined segments. Embodiments of the present invention provide a segment-definition language (“SDL”) that allows users and developers to abstractly define segments in a data-independent manner. The SDL provides many operators and constructs for creating and defining segments. SDL-based subsystem components execute SDL segment definitions to assemble segments on behalf of application programs.

### BRIEF DESCRIPTION OF THE DRAWINGS

FIG. 1 provides a context for discussion of method and system embodiments of the present invention.

FIG. 2 shows a simple, exemplary web page.

FIG. 3 shows the contents of an HTML file that encodes the exemplary web page shown in FIG. 2 and that includes simple modifications to facilitate data collection.

FIG. 4 provides a tree-like representation of the contents of the exemplary HTML file shown in FIG. 3.

FIG. 5 illustrates a simple web site comprising seven web pages.

FIGS. 6-7 illustrate factors, factor levels, and test design.

FIG. 8 illustrates the concept of segments in testing of web pages.

FIG. 9 illustrates the data and data structures that define tests, test runs, and experiments.

FIG. 10 illustrates the nature of the statistics, or test results, that are collected for a particular test-run.

FIG. 11 illustrates an example testing environment.

FIGS. 12A-H illustrate a general method and system for web-site testing.

FIG. 13 provides an abstract illustration of data input and data processing within a-web-analysis system.

FIGS. 14A-B illustrate several types of segment-based data operations commonly encountered in a web-analysis system.

FIG. 15 provides an example of embedded. SDL according to one embodiment of the present invention.

FIG. 16 illustrates interactive SDL, which represents one embodiment of the present invention.

FIGS. 17 and 18 illustrate conceptual features of SDL, which represent one embodiment of the present invention.

FIG. 19 provides a table of a number of SDL statement types according to one embodiment of the present invention.

FIG. 20 illustrates the components of a web-analysis system or other computer system that implement SDL according to one embodiment of the present invention.

FIG. 21 illustrates a generalized computer architecture for a computer system that, when controlled by segment-subsystem component programs to generate and execute segment definitions, represents one example of the present invention.

### DETAILED DESCRIPTION

The present invention is directed to various tools and facilities for definition and population of segments to facilitate automated data analysis and automated experimentation based on user interaction with web pages, web sites; and other user interfaces. These tools and facilities are based on a segment definition language (“SDL”) that represents one embodiment of the present invention. The SDL is additionally useful for defining segments in many additional contexts, including by clients of web-analysis systems to identify and interact with users and by any of various service-provision, retailing, and information-provision organizations that interact with users. In a first section, below, an example web-analysis system is described, in detail, to provide context for the types of systems in which SDL finds application. In a second subsection, the SDL and an SDL implementation is described. In a third subsection a first example interactive SDL session is described, and in a fourth subsection, a second example interactive SDL session is described.

### Example Web-Analysis System that Provides a Context for Application of the SDL

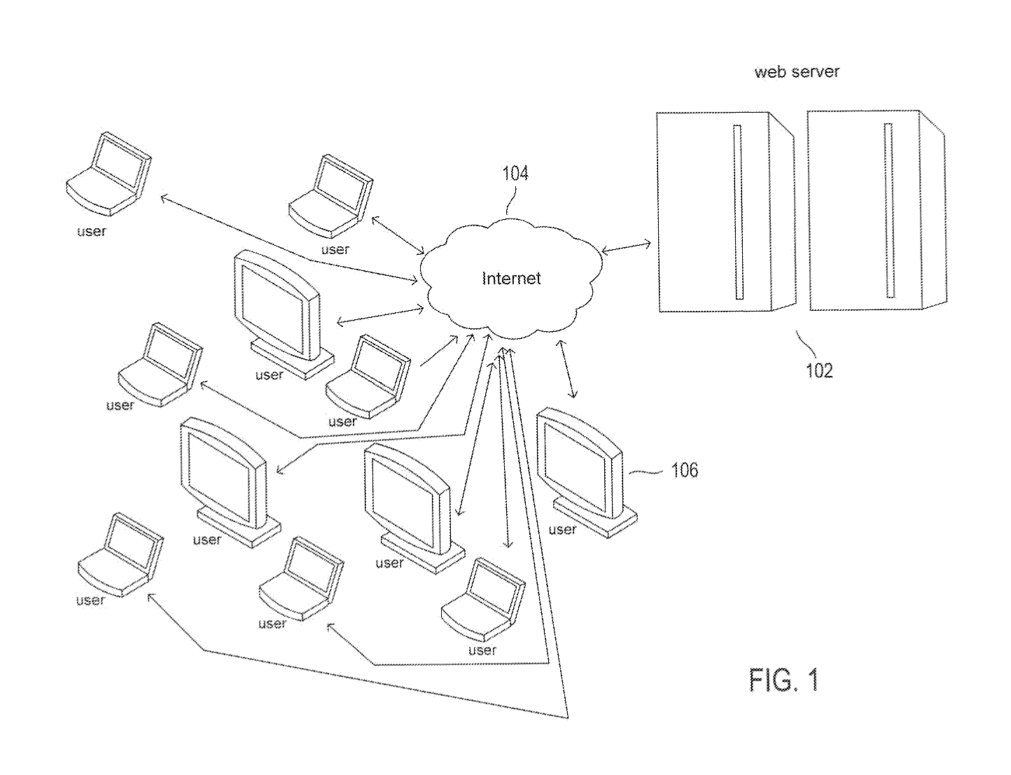

FIG. 1 provides a context for discussion of method and system embodiments of the present invention. In FIG. 1, a server 102, comprising one or more servers and/or other types of computer systems, transmits HTML-encoded web pages through the Internet 104 to a large number of user or customer computers, including as user computer 106. As discussed above, the web server may be owned and operated by an Internet retailing organization, an information-distribution system, a social-networking system, or another type Internet-based transactional or content-distribution system. In general, the web server runs continuously, at all times during the day and night, providing HTML-encoded web pages and, usually, additional types of information and services, including downloads of executable code, scripts, and other such information for specific types of web-based applications.

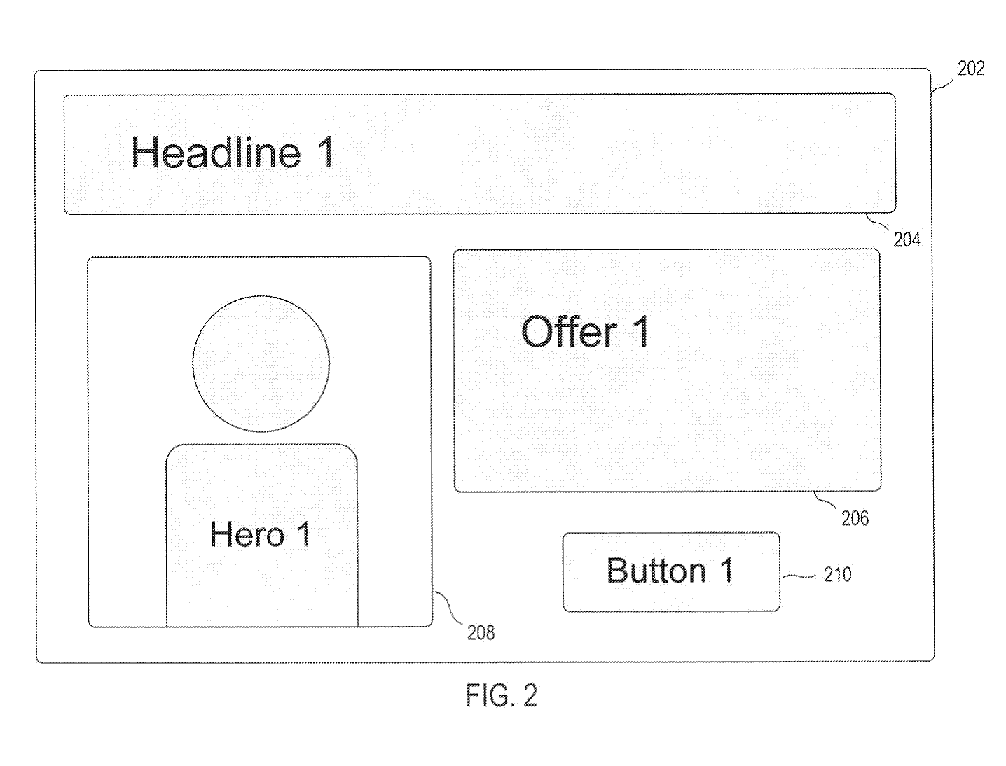

FIG. 2 shows a simple, exemplary, web page. A web page is described by an HTML file, discussed below, which is processed by a web browser executing on a computer in order to generate a web page, as shown in FIG. 2, that is displayed to a user on a display device. The exemplary web page 202 includes a headline graphic 204, an offer graphic 206, a hero graphic 208, and a button graphic 210. The exemplary web page is subsequently discussed in the context of tests and experiments in which altered versions of the web page are provided to users of the web server, that serves the web page in order to test the effects of modifications to the web page.

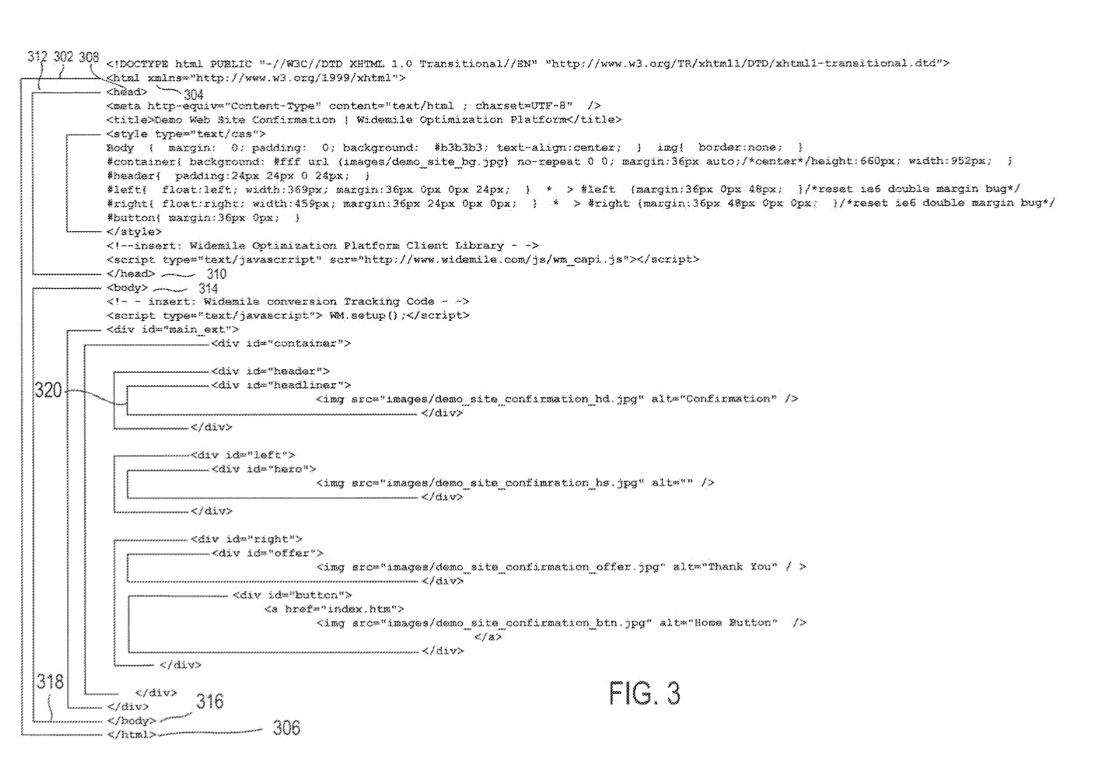

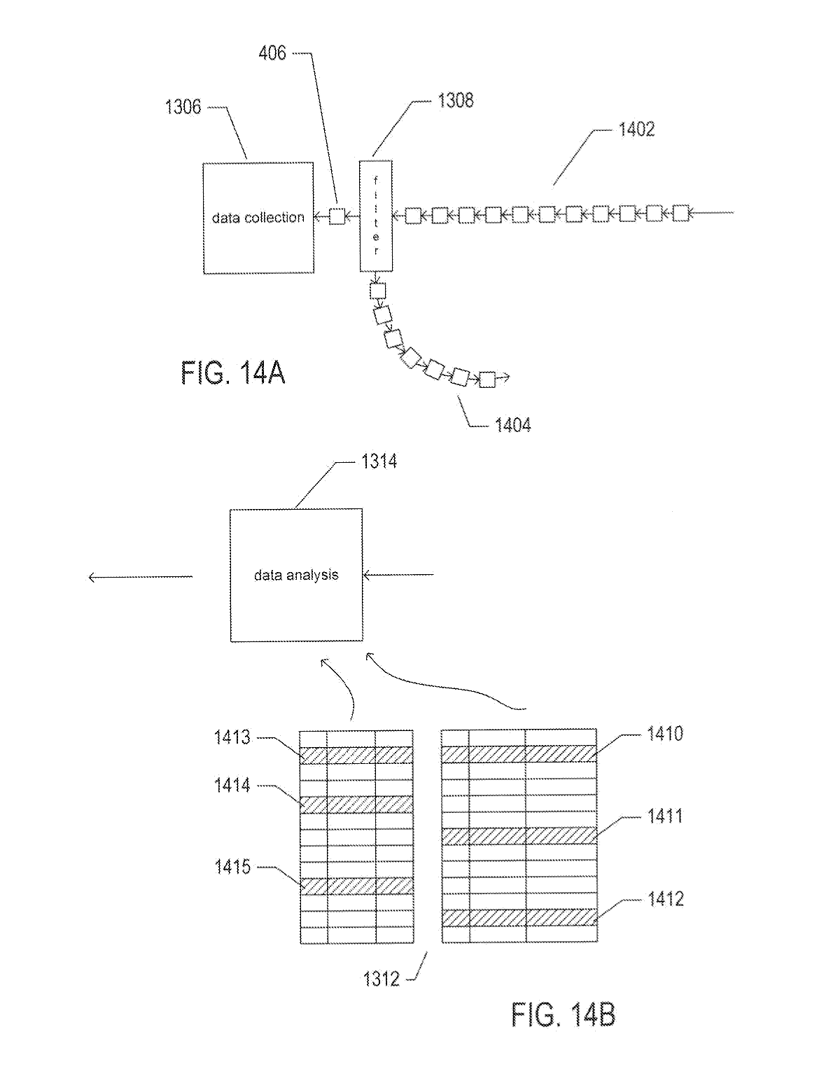

FIG. 3 shows the contents of an HTML file that encodes the exemplary web page shown in FIG. 2 and that includes simple modifications to facilitate data collection. The modifications, used to virtually incorporate a testing service into a website are discussed below, with reference to FIG. 14.

A complete discussion of HTML is beyond the scope of the current discussion. In FIG. 3, portions of the HTML file are correlated with features in the displayed web page shown in FIG. 2. In addition, general features of HTML are illustrated in FIG. 3. HTML is hierarchical, in nature. In FIG. 3, double-headed arrows, such as double-headed arrow 302, have been drawn to, the left of the HTML code in order to illustrate tags and tag scoping within the HTML file. In general, HTML statements are delimited by a pair tags, and are hierarchically organized by scope. For example, an outermost statement begins with a first tag of a tag pair that begins with the text “<html xmlns=” (304 in FIG. 3) and ends with a last tag of the tag pair that begins with the text “</HTML” (306 in FIG. 3). The scope of outermost statement encompasses the entire HTML code. The double-headed arrow 302 at the left of the HTML code, which represents the scope of this statement, spans the entire HTML file. A second-level that begins with the first tag of a tag pair “<head>” 308 and ends with the last tag of the tag pair “</head>” 310 spans a first portion of the HTML file, as indicated by double-headed arrow 312, and a second statement bounded by the first and last tags of a tag pair “<body>” 314 and “</body>” 316 span a second portion of the HTML, file, indicated by double-headed arrow 318. By examining the tags within the exemplary HTML file, shown in FIG. 3, and the double-headed indications of the scope of tag-delimited statements, the hierarchical nature of HTML can be readily appreciated.

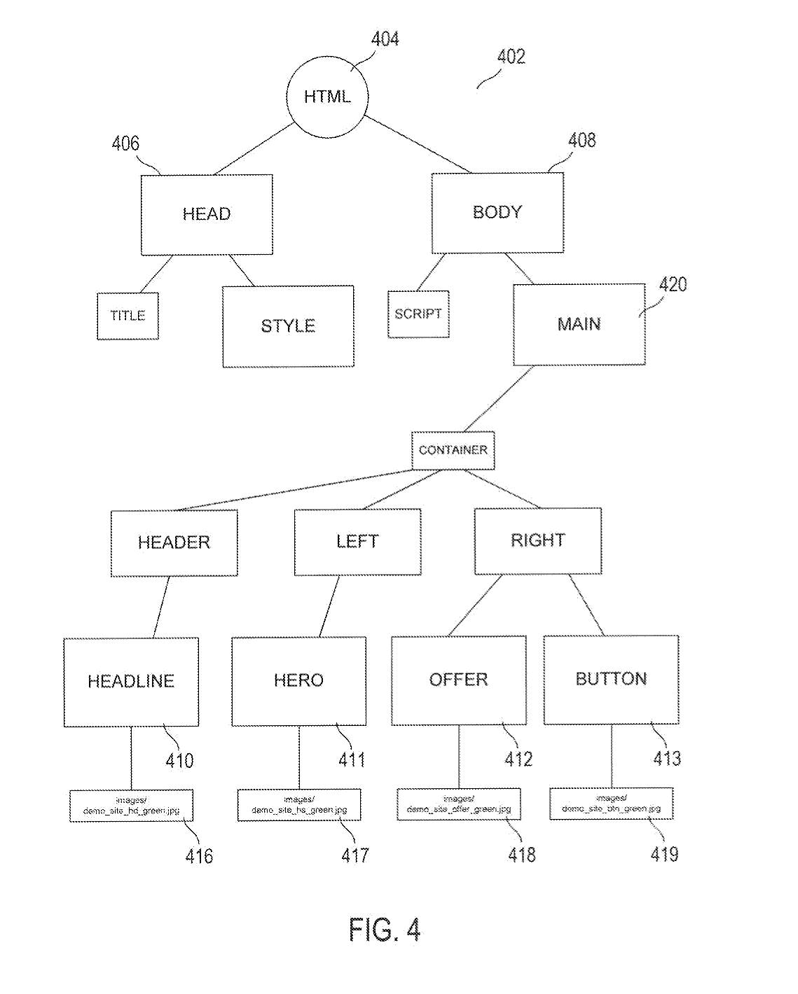

FIG. 4 provides a tree-like representation of the contents of the exemplary HTML file shown in FIG. 3. The tree 402 shown in FIG. 4 is constructed from the double-headed arrows that annotate the HTML code, in FIG. 3, that span the scopes tag-delimited statements in the exemplary HTML file. For example, the root node 404 corresponds to double-headed arrow 302, and the second level “head” 406 and “body” 408 nodes correspond to double-headed arrows 312 and 318 in FIG. 3, respectively. Note that, at the very bottom of the tree representation of the HTML file, shown in FIG. 4, the four leaf nodes 416-419 represent the four features 204, 206, 208, and 210 of the displayed web page encoded by the exemplary HTML file, shown in FIG. 2. Each of these nodes is essentially a reference to an, image file that contains a jpeg image of the corresponding web-page feature. The head statement, represented by node 406 in FIG. 4, includes formatting information, references to highest-level resource-location directories, and a great deal of additional information that is used by a browser to plan construction of a displayed web page. The body statement, represented by node 408 in FIG. 4, includes references to image files, text, and other features that are rendered by the browser into displayed features of the web page. Intermediate nodes include identifiers, particular met-data information, and references to scripts that are downloaded and run by the web browser during web-page rendering and/or display.

As a specific example, node 416, a direct and only descendant of the node labeled “headline” 410 in FIG. 4, corresponds to the headline feature 204 displayed in the exemplary web page shown in FIG. 2. This node also corresponds to double-headed arrow 320 in FIG. 3. The statement “<img src=“images/demo_site_green.jpg” indicates that the displayed object is encoded as a jpeg image “demo_site_offer_green.jpg” that can, be found in file-system sub-directory “images.”

In order to transform an HTML file into a displayed web page, a web browser constructs a tree-like binary-encoded data object referred to as a “document object model” (“DOM.”) The exact contents and structure of a DOM is beyond the scope of the present invention. However, certain web-analysis methods and systems rely on standardized DOM-editing interfaces that provide routines to identify nodes and subtrees within a DOM and to edit and modify identified nodes and subtrees. Once a browser has created a DOM from the exemplary HTML file shown in FIG. 3, DOM-editing routines can be used to locate the node in the DOM corresponding to the node “headline” 410 in FIG. 4 and replace or modify that node to reference a different image. Following modification, the web browser would then display a modified web page in which the headline image 204 in FIG. 2 is replaced by a different image. To effect more dramatic changes, an entire subtree of a DOM, such as the subtree rooted by a node corresponding to the node “right” 420, can be removed or replaced, to change groups of display features. While the discussed web-analysis system uses DOM tree modification techniques, other types of modification techniques provided by interfaces to other types of binary representations of web pages may be used. The DOM is only one of many possible binary representations that may be constructed and employed by web browsers.

Another feature of the exemplary HTML file shown in FIG. 3 is that the various features displayed in FIG. 2 are, in HTML, wrapped by tag-delimited identifiers. For example, the “wm_headline” tag indicated by double-headed arrow 320 and by node 410 in FIG. 4 is an identifier for the headline-image-reference statement 322. Alphanumeric identifiers, such as the identifier “wm_headline,” are introduced into an HTML file in order to give, easy-to-understand and easy-to-use labels or handles for various objects, particularly objects that correspond to displayed features in a web page. Although objects can be easily identified in this manner, other methods for identifying objects within an HTML file, as well as corresponding nodes of DOM trees and other such binary representations of a rendered page, can be used to reference display objects.

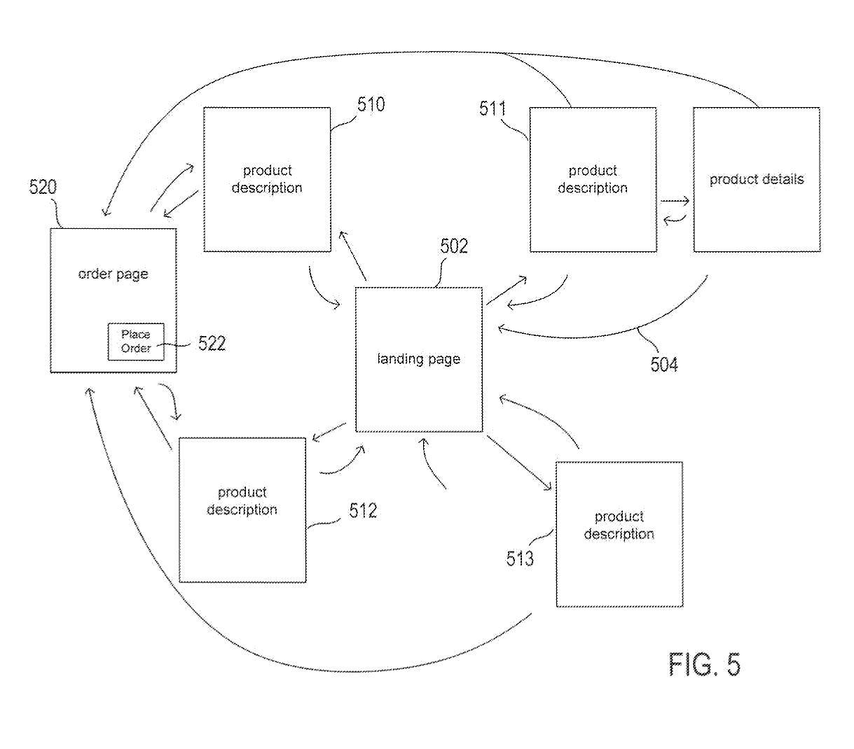

FIG. 5 illustrates a simple web site comprising seven web pages. Each web page, such as web page 502, is represented by a rectangle in FIG. 5. Curved arrows, such as curved arrow 504, indicate navigational paths between the web pages. Accessing the web site illustrated in FIG. 5, a user generally first accesses a landing page 502 as a result of clicking a link provided by another web page, such as a web page provided by a search engine, or provided in a list of bookmarked links by a web browser. The landing page is often, but not necessarily, a home page for the website. A home page is a central portal for, access to all of the remaining web pages in the web site. In general, a user navigates through the web site by clicking on displayed links embedded in web pages. For example, the web site illustrated in FIG. 5 is a retailing web site. The landing page provides links to four different pages 510-513 that provide product descriptions for four different products. A user, after viewing the landing page 502, may click a link in order to navigate to a display of a product-description page 510. In the exemplary web site shown in FIG. 5, a user may subsequently navigate from a product-description page or product-details page to a central order page 520 that contains a button or feature 522 to which the user can input a mouse click in order to order one or more products. In certain cases, web sites may comprise a single page and, in other cases, a web site may comprise tens to hundreds or more pages, linked together in a network-like graph describing various navigational paths between web pages.

An example application of web-site testing, would be to monitor access, by users, of the web pages shown in FIG. 5 in order to attempt to determine how often users end up navigating to the order page and clicking the place-order button 522. One might then modify one or more of the pages, and again monitor users' access to the pages and subsequent input to the place-order button 522. In this way, by testing collective user response various alternative web pages, web-site developers and managers may be able to determine an optimal set of web pages that provides the highest ratio of inputs to the place-order button 522 to user accesses of the landing page 502. In testing parlance, clicking the place-order button 522, in the exemplary web site shown in FIG. 5, is, in this example, considered to be a conversion event. One goal of optimizing the web site might be to increase the percentage of users clicking on the place-order button 522 after initially accessing the landing page 502. However, conversion events may be arbitrarily defined, and there may be multiple conversion events for a particular web site. Optimization of a web site may also involve multiple, often at-least partially contradictory goals. One goal may be to increase the number of accesses to any page other than the landing page by users who have initially accessed the landing page. Another goat may be to increase total accesses to the landing page, regardless of subsequent page accesses by users accessing the landing page. Another goal may be to obtain maximum possible conversion rates, even at the expense of decreasing the overall rate of page accesses.

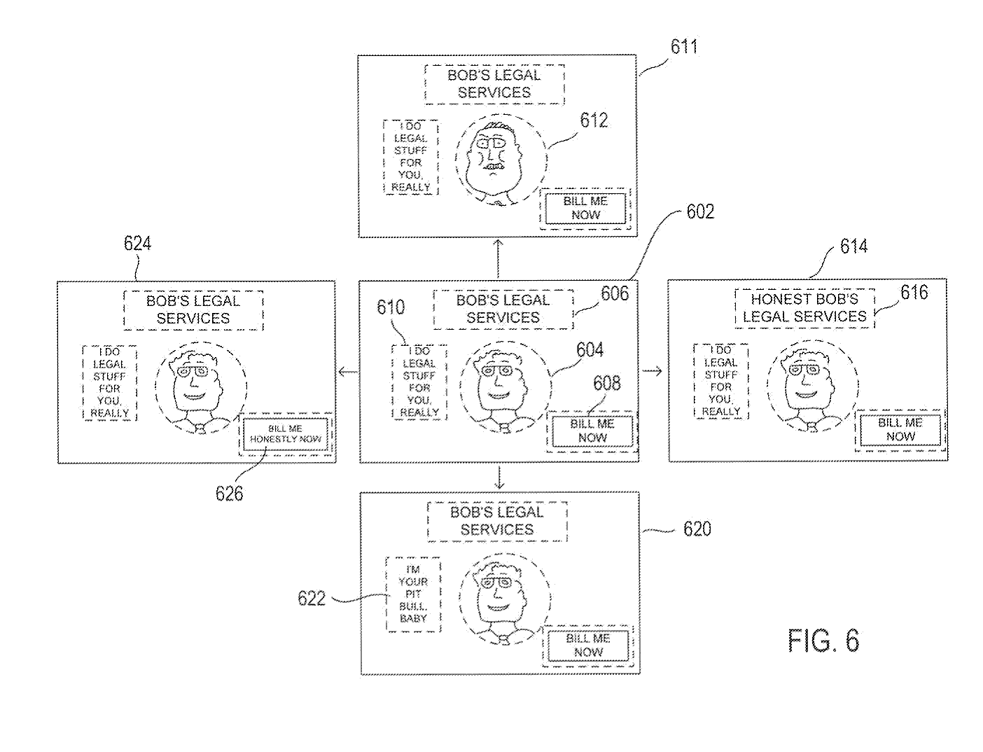

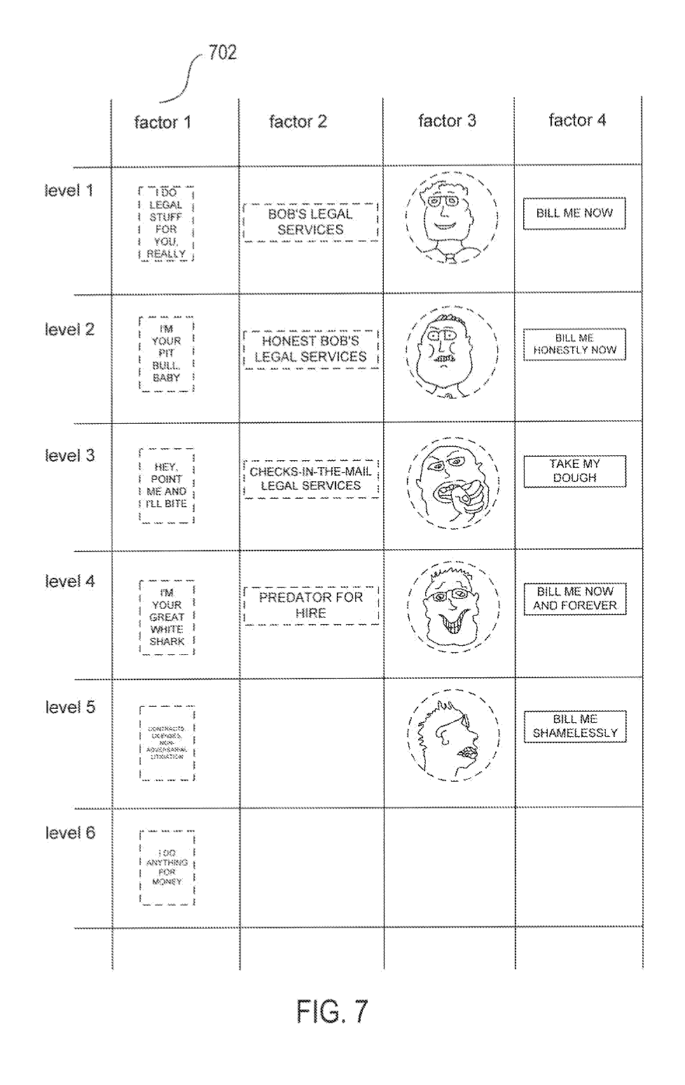

FIGS. 6-7 illustrate factors, factor levels, and test design. In FIG. 6, an initial, prototype web page 602 is shown. A web-site owner or developer may decide to systematically alter the prototype web page in order to test the effects of the systematic alterations, so that alterations that appear to maximize goals can be made to the web page in order to optimize the web page. The prototype web page includes a portrait image 604, a title 606, a user-input feature 608; and an informational message 610. A systematic tester may decide to alter each of these web-page features, one-at-a-time, in order to determine, the effects of the altered features on measured user response. For the web page shown in FIG. 6, the measured user response, or conversion event, would likely be user input to the user-input feature 608. As shown in FIG. 6, a tester may devise a first test web page 611 in which the prototype image 604 is replaced with a different image 612. The tester may devise a second test page 614 in which the title feature 606 is replaced with a different title feature 616. Similarly, the tester may devise a third test page 620 in which the informational message 610 of the prototype web page is replaced with a different informational message 622. Finally, the tester may create a fourth test web page 624 in which the user-input feature 608 of the prototype web page is replaced with a differently labeled user-input feature 626. The systematic tester may change a single feature, in each of the four test pages, in order to judge the effect of changing that feature in isolation from any other changes to the web page that might be contemplated. However, the strictly one-feature-change-at-a-time method would fail to provide data for the effects of various combinations of changes, such as changing both the headline and a portrait and, moreover, would require significant developer time and effort.

FIG. 7 illustrates a related approach to the testing approach discussed with reference to FIG. 6. In FIG. 7, the tester has prepared a table of factors and factor levels. Each factor in the table is represented by a column, such as the first column 702 corresponding to factor 1. Each factor is a feature, or group of related features, on a displayed Web page that the tester wishes to alter in order to determine whether or not to alter the feature in order to optimize the web page with respect to one or more optimization goals. The various alternatives for each factor are referred to as levels. Thus, for example, factor 1, represented in the table by column 702, corresponds to the information message (610 in FIG. 6), for which the tester has devised six different alternative's, each corresponding to one of six different levels associated with that factor. The tester has devised four alternatives for factor 2, the title feature (606 in FIG. 6), five alternatives for factor 3, the portrait feature (604 in FIG. 6), and five alternatives for the fourth factor; the user-input feature (608 in FIG. 6). Then, having specified the factors, or web-page features, to be altered, and the various different alternatives for each feature, the tester might try generating all possible test pages corresponding to all possible combinations of level values for the factors in order to test the different alternative web pages to determine an optimal set of four levels corresponding to optimal alternates for the four factors. Unfortunately, an exhaustive, combinatorial test, in most cases, is not feasible. Even for the very simple example of FIGS. 6 and 7, there are 1260 different alternative pages, including the prototype page, which can be constructed by varying between one and four factors according to the variations, or levels, provided in the table provided in FIG. 7. In general, for the statistics collected from testing to have significance, a sufficient number of tests need to be conducted so each of the different test pages is displayed a relatively large number of times during the test. In the example of FIGS. 6 and 7, each different alternative web page among the 1260 possible alternative web pages may need to be displayed hundreds or thousands of times to users in order to accumulate sufficient test data to make valid statistics-based judgments. In many cases, the number of factors and number of levels for each factor may be far larger than in the simple example shown in FIGS. 6 and 7.

The variations of factors, or levels, may include changes in content, display size, display color, object position in the displayed image, or many other different types of changes. Again, as discussed above, a factor may include multiple display features.

Because of the general infeasibility of full, exhaustive, combinatorial testing of all possible web-page variations, certain web-analysis methods and systems use an experimental-design method referred to as “the orthogonal-array method.” This method devises a non-exhaustive test strategy that nonetheless gathers sufficient, well-distributed test data in order to make reasonable inferences with regard to the effects of altering the factors in all possible ways. In essence, the orthogonal-array method involves devising a sparse sampling of all possible variations of the web page that provides information about the various dependencies between the different levels of the different features. The orthogonal-array method involves specifying the factors and specifying the levels for each factor for a particular test run, and then, based on the factors and levels for each factor to be tested in a particular test, run, devises a set of alternative web pages, by varying the specified factors according to the specified levels, that provide a good basis for collecting statistics for the features to be tested. The orthogonal-array method is well known in testing and statistics. Many additional types of test-design methods may also be used. Whatever test-design technique is employed, each test run defined by clients is associated with a test design that controls generation and distribution of experiments, or modified web pages.

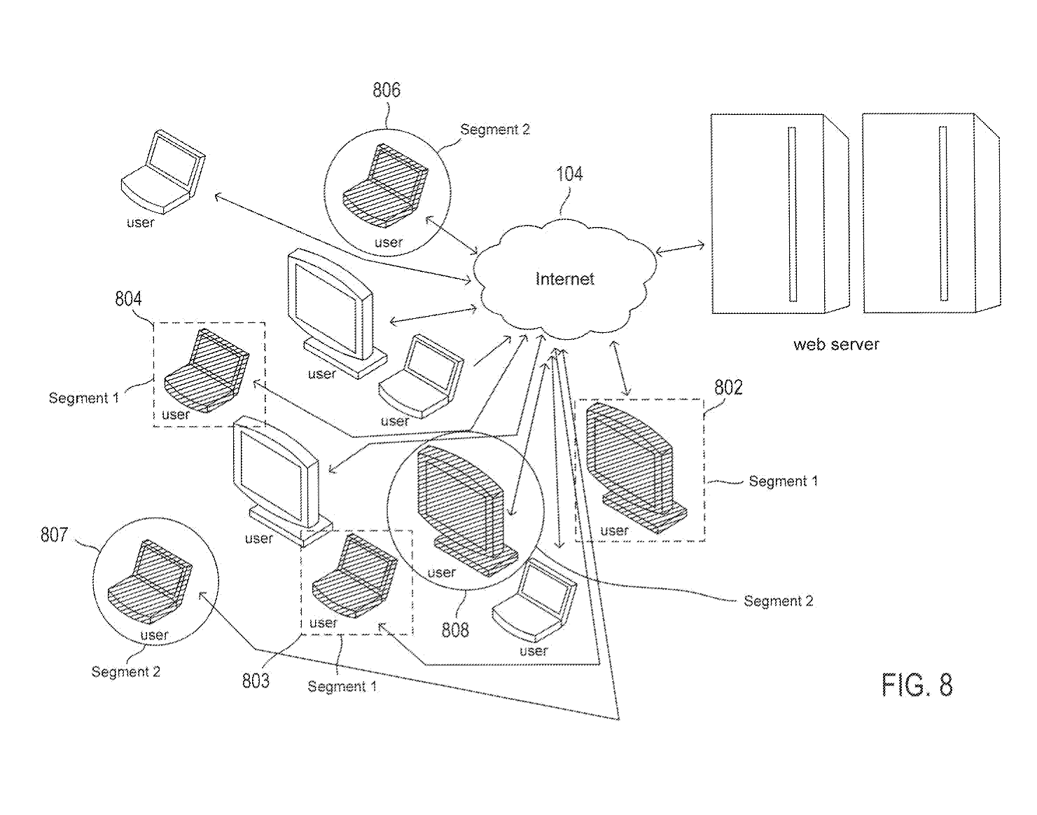

FIG. 8 illustrates the concept of segments in testing of web pages. FIG. 8 shows the web server and users of the web server using the same illustration conventions as used in FIG. 1. However, in FIG. 8, a first set of three users 802-804 are marked as belonging to a first segment, segment 1, and a second set of three users 806-808 are marked as belonging to a second segment, segment 2. During live, real-time testing of web sites, alternative versions of web pages are provided to subsets of the total number of users, or customers, accessing the web server. During a particular test run, altered web pages are provided to a specified segment of users. A segment of users, or customers, can be defined by any of a wide variety of different parameters. For example, a segment of users may be defined by the web page or link by which the users or customers navigated to a test page served by the web server. Segments may be defined by time periods, by the Internet domains through which users access the Internet, or by many other different criteria.

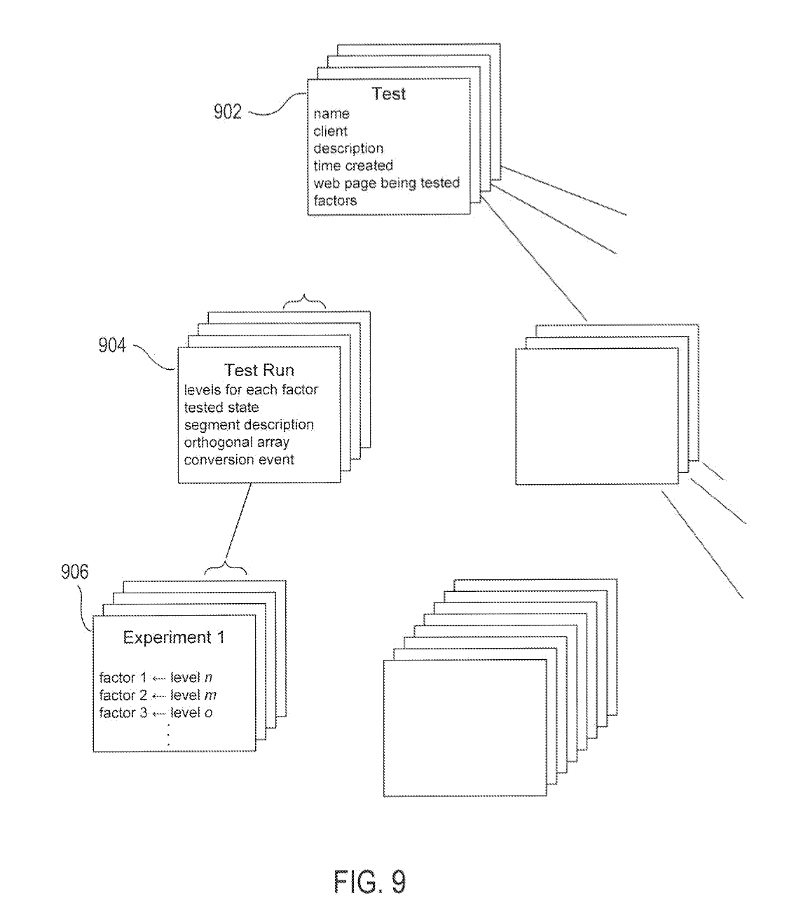

FIG. 9 illustrates the data and data structures that define tests, test runs, and experiments. A testing service may, at any given time, carry out a large number of different tests for many different client web-site-based organizations. Each test is defined by a test record, such as test record 902 in FIG. 9. Information contained in the test record includes an alphanumeric name of the test, an identifier for the client on behalf of whom the test has been created, a description of the test, an indication of the time that the test was created, an indication of the web page that is tested by the test, and a list of the factors that may be involved in any particular test run associated with the test. Note that the factors can be specified by the identifiers associated with features or objects displayed in the web page. For example, referring to FIGS. 2-4, a list of factors for a test of the exemplary web page shown in FIG. 2 may include the alphanumeric strings: “wm_headline,” “wm_hero,” “wm_offer,” and “wm_button.”

Any particular test may be carried out over a series of test runs. For example, each test run may be carried out at a different time, with respect to a different segment of users, and may test a different array of features and feature levels. Thus, each test record, such as test record 902 in FIG. 9, may be associated with one or more test-run records, such as test-run record 904 in FIG. 9. Test-run records include information such as the levels to be used for each factor; with the levels specified as URLs, or other references to images and other resources, or as text strings or other data directly displayed by the browser, a current state of the test run, a description of the segment to which the test run is directed, an indication of the particular orthogonal-array basis or other test design for the test run, and an indication of one or more conversion events for the test run. Finally, using the orthogonal-array basis or other test design selected for the test run, a test run is associated with a set of experiments, such as experiment 906 in FIG. 9. Each experiment corresponds to an altered web page that is displayed to users during, the test run. An experiment is essentially defined by associating each factor, tested in the test run, with a particular level, or referenced resource, according to a matrix of test pages generated by the orthogonal-array basis or other test design selected for the test run.

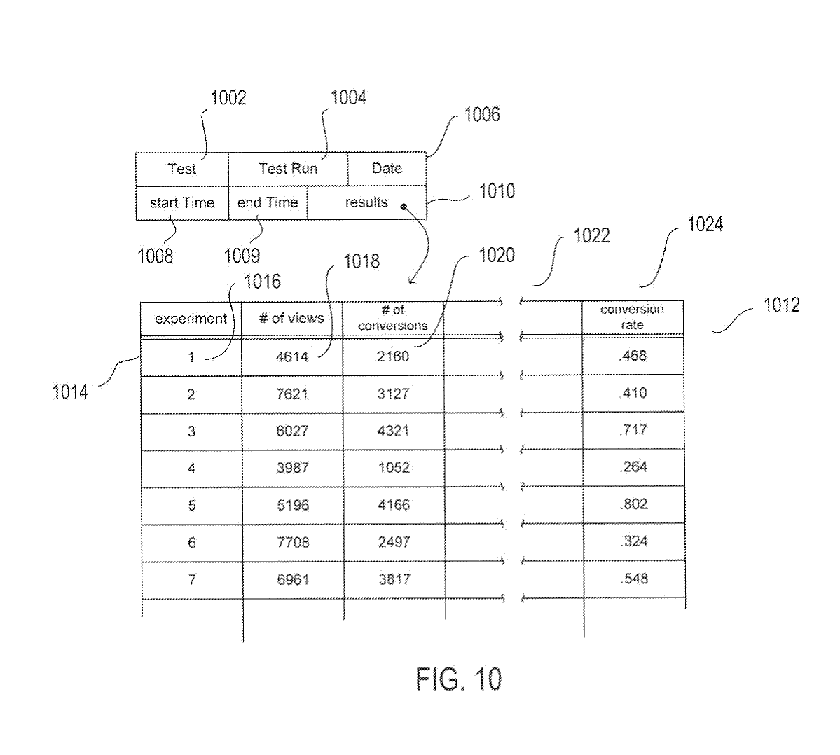

FIG. 10 illustrates the nature of the statistics, or test results, that are collected for a particular test run. The results include indications of the test 1002 and test run 1004, the date on which the test run was conducted 1006, a start time and an end time for the test run 1008-1009, and a reference 1010 to a results table 1012 in which test results are tabulated. The test results table includes a row for each experiment associated with the test run, such as row 1014 in experimental-results table 1012. The row includes an indication of the experiment to which the row corresponds 1016, a count of the number of the times that the page corresponding to the experiment was accessed by a user of an active segment 1018, an indication of the number of tunes that a user who accessed the test page generated a corresponding conversion event 1020, other similar numerical information in additional columns 1022, and, finally, a computed conversion rate 1024 for each experiment. The test results shown in FIG. 10 are but one example of the type of statistics and data that can be collected during a test run. Different or additional statistics may be collected according to different test configurations created by test-service clients.

There are many different possible ways of testing a web server in order to accumulate test results, discussed above with reference, to FIG. 10, for tests defined for particular web pages and factors associated with those web pages, as discussed above with reference to FIG. 9. One method would require the web server to design a test by creating all or a subset of possible alternative test pages and to then develop a test-page-serving system that would execute concurrently with, or as part of, the web server on an intermittent or continuous basis. As discussed above, testing methods and systems that require the web server to develop and run tests may be prohibitively expensive, both in time and resources, for web-site owners or web-site-based organizations. Furthermore, such testing methods can inadvertently cause serious financial losses and other non-financial damage to a web site. For example, were the test pages improperly constructed or served, sales or other activities generated by real-time users may be lost and, in worst cases, the web site could potentially lose business from particular customers and users altogether. Real-time testing additionally involves significant security risks. A malicious hacker or employee might be able to alter the test system to display fraudulent or offensive test pages, for example. Finally, similar to problems encountered in a variety of physical and behavioral systems, poorly or improperly design tests may so perturb the system being tested that the statistics collected from the tests are meaningless or, in worst cases, lead to false conclusions. For example, a poorly designed test engine may introduce significant delays in web-page service to customers or users. As a result, the conversion rate measured during a test run may fall precipitously, not because of particular alterations made to test web pages, but instead because the significant time delay encountered by users for whom the test page is constructed and to whom the test web page is transmitted. For these, and many other reasons, web-site-based-organization test design and execution can be undesirable and in worst cases, disruptive and damaging to the web-site-based organization.

An alternative approach involves using a third-party testing service, in tandem with the web server that serves the web site to be tested. However, simply conducting tests by a third-party server does not guarantee that the many pitfalls and disadvantages discussed above with respect to web-site-based-organization test design and execution are necessarily avoided. In fact, in many cases, the pitfalls and disadvantages discussed in the preceding paragraph may be exacerbated by third-party testing of web sites and web servers. For example, in the case that a test web, page, requested by customer, needs to be prepared by the third-party server, in response to a request generated by the web site as a result of a user request for the web page being tested, test-page serving may be significantly delayed, deleteriously perturbing the users' interaction with the web server to the point that the test statistics end up meaningless or misleading. As another example, security issues may be compounded by distributing testing tasks between a web-server computer system and a third-parting testing server. Web-analysis methods and systems employ an array of techniques and features that address these pitfalls and disadvantages, and that provide minimally intrusive and cost-effective testing for web sites and web servers.

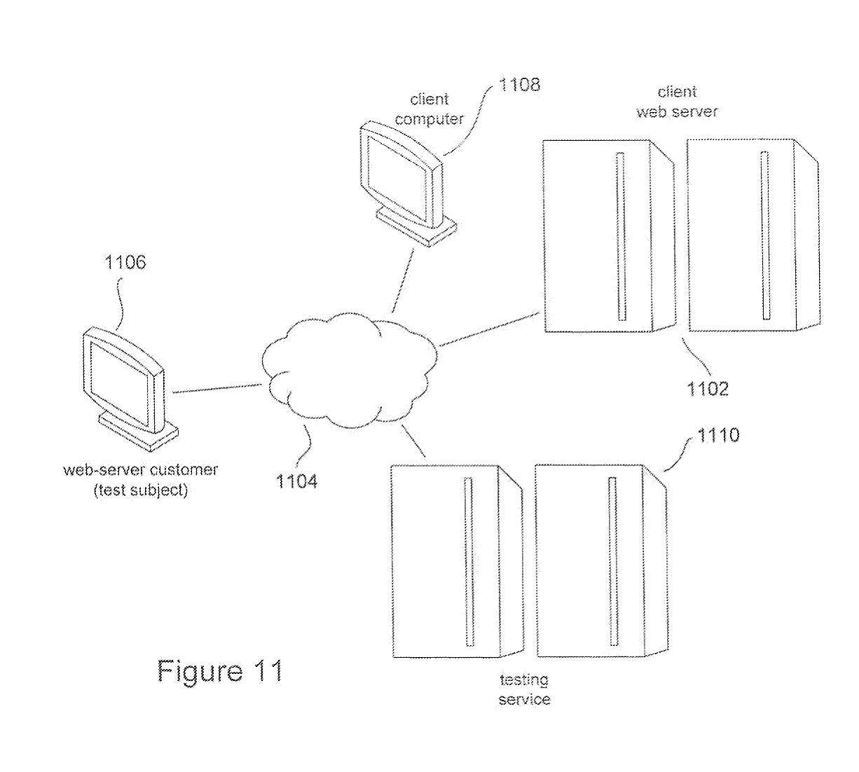

FIG. 11 illustrates the testing environment for carrying out web-site testing. In FIG. 11, the web site 1102 is represented as one or more servers or large computer systems that serve web pages through the Internet 1104 to a generally large number of web-site users or customers, including user 1106. The web site or web server is regarded, in the following discussion, as a client web server of the testing service. The client web server also includes a client computer 1108 by which the client web-server-based organization can access various third-party services and web servers through the Internet. Finally, a web-site testing service is provided by a distinct server or servers 1110 accessible to the client web server 1102, the web server customer 1106, and client computer 1108 via the Internet 1104.

The testing service is used by the client web-site-based organization, referred to as the “client,” below, to design and run real-time, live tests of web pages provided by the client web server to users. The testing service, may run, on the same computer systems as the client web server. In general, the testing service is geographically distinct from the client web server, and is concurrently used by multiple, different clients for concurrently executing many different test runs on behalf of the multiple clients.

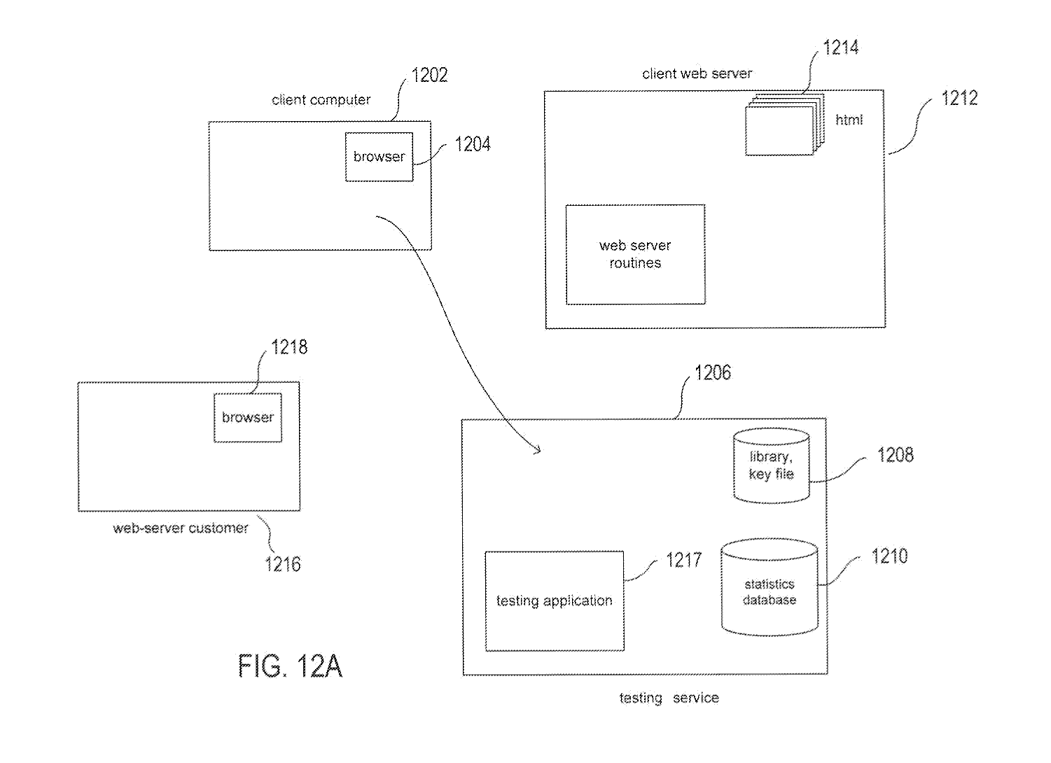

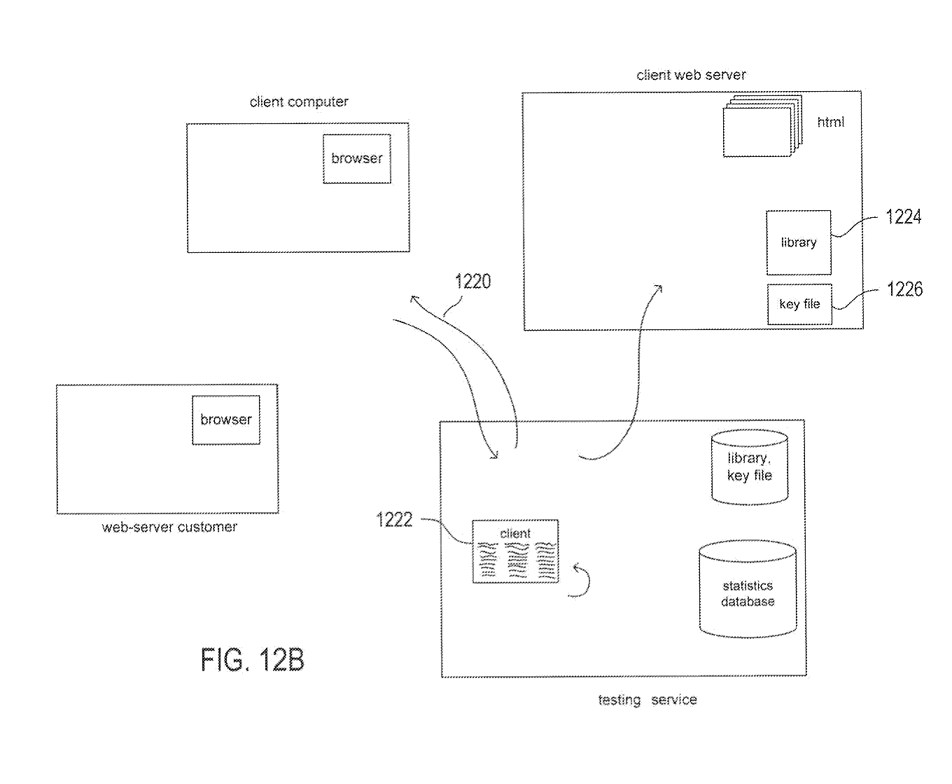

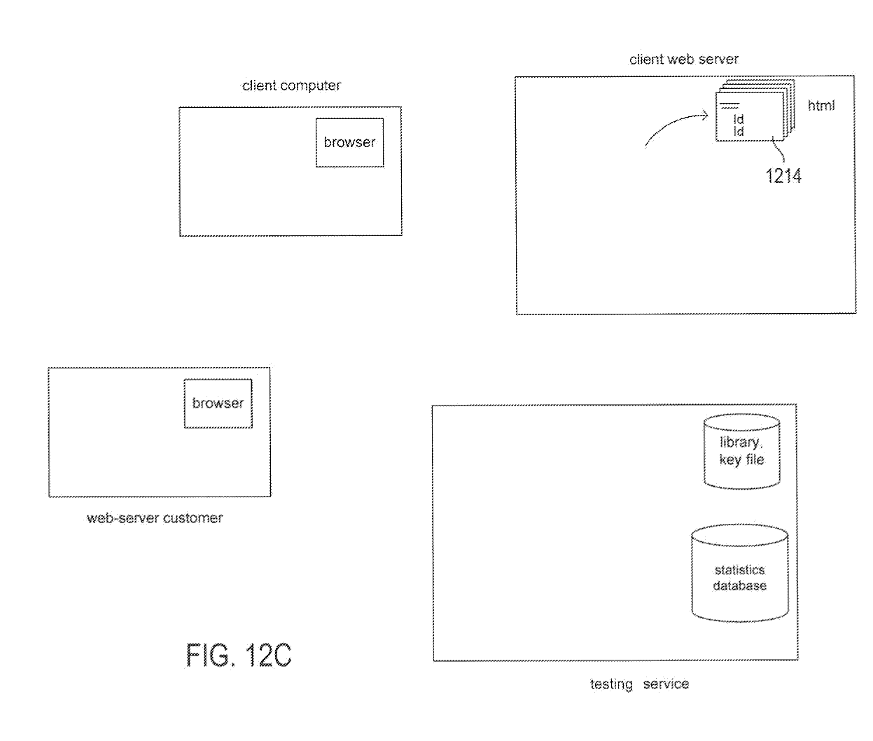

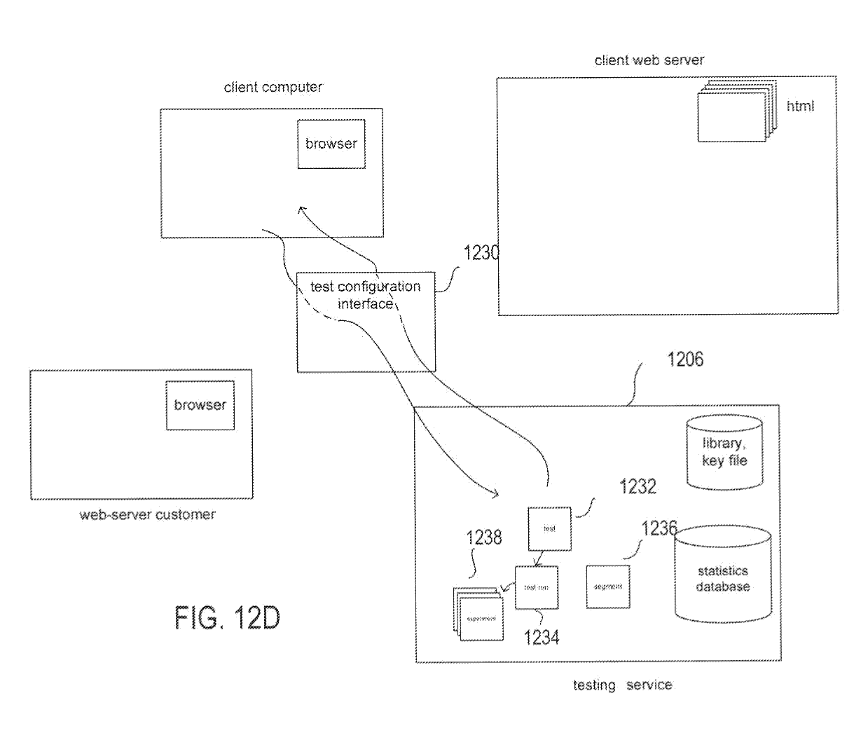

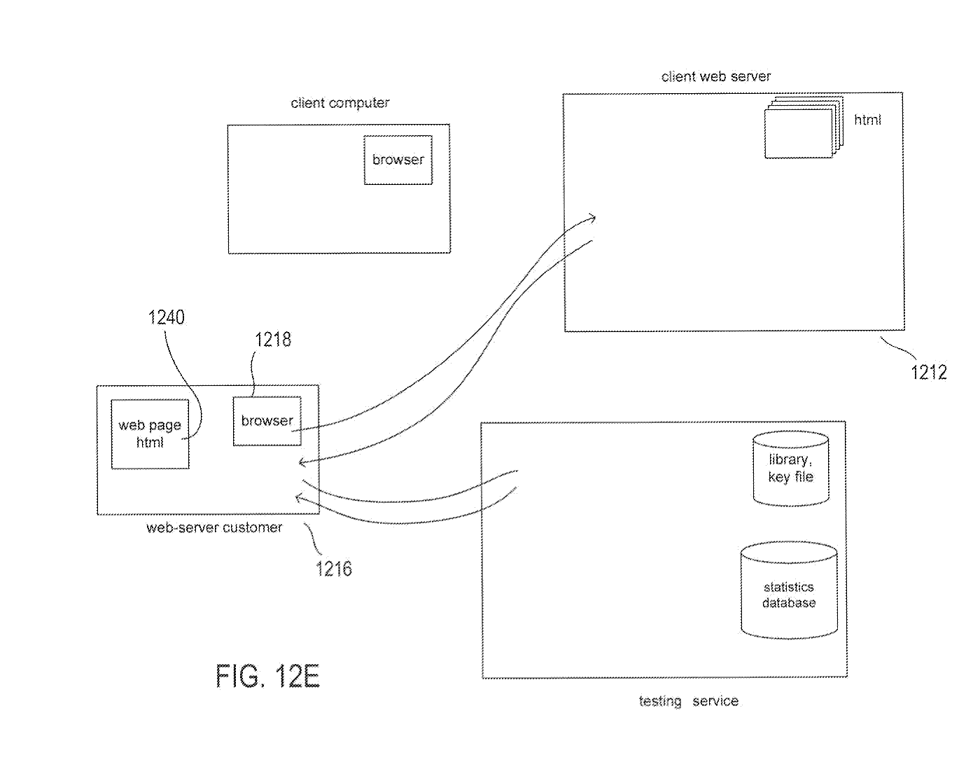

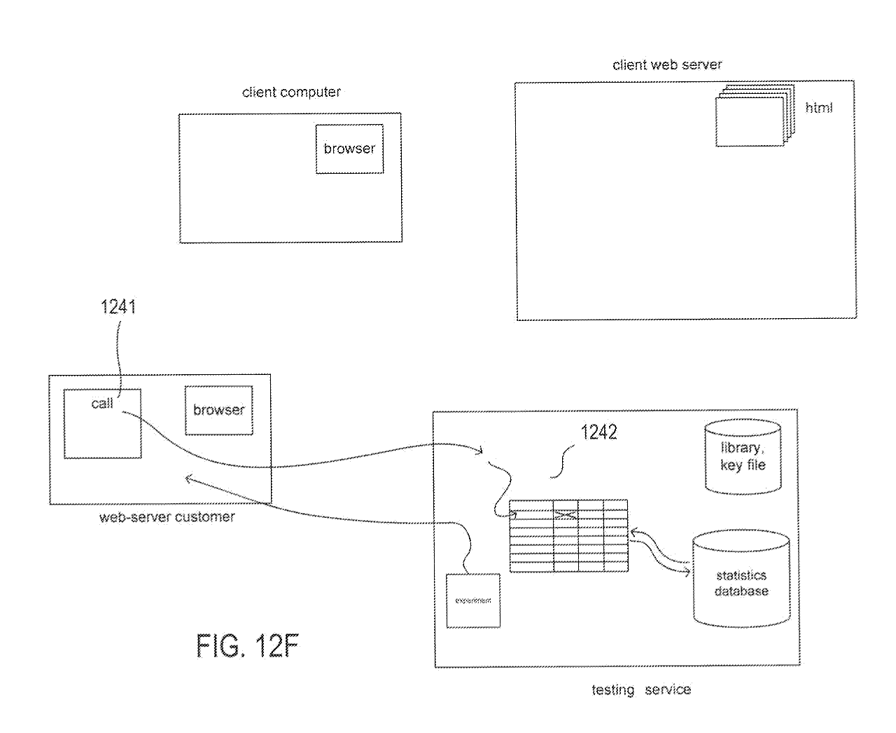

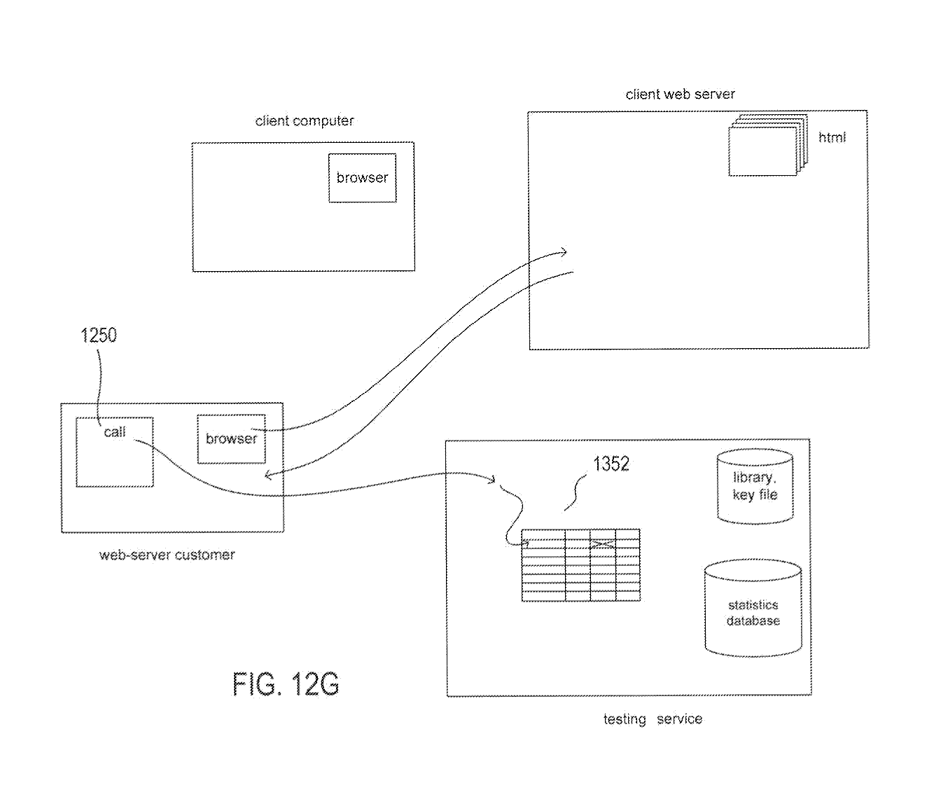

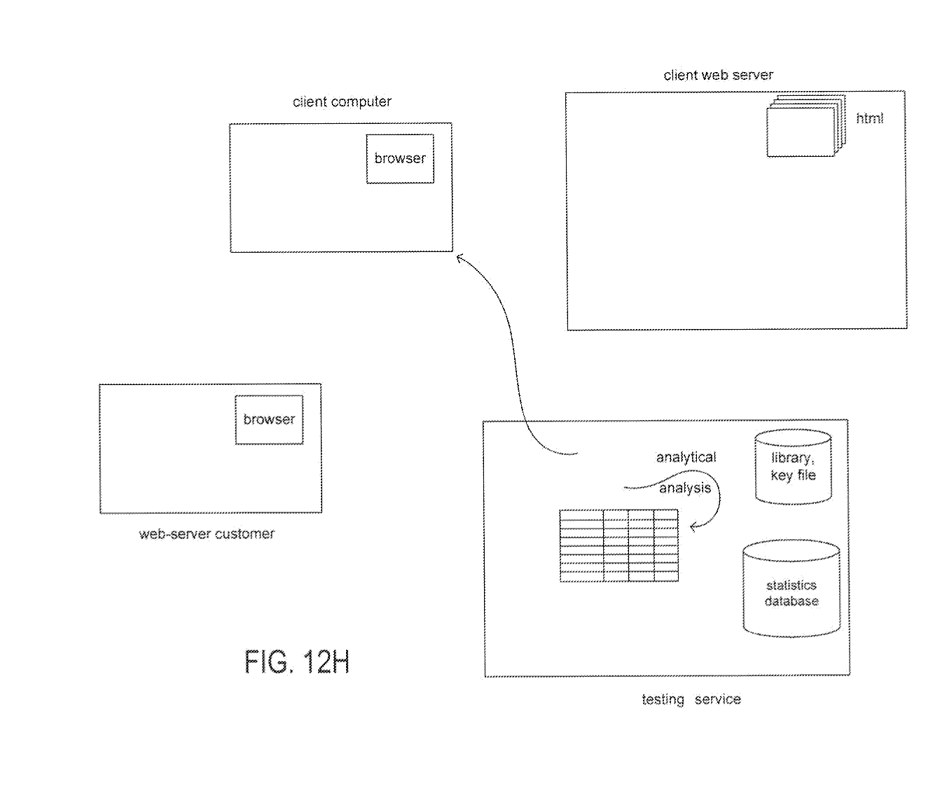

FIGS. 12A-H illustrate the general method and system for web-site testing. FIGS. 12A-H all use the same illustration conventions, in which large rectangles represent the four entities shown in FIG. 11.

A client establishes a relationship with the testing service; as shown in FIG. 12A, by accessing the testing service through a browser executing on the client computer. As shown in FIG. 12A, an employee or owner of the client web server uses the client computer 1202 to access a testing-service web site, via a browser 1204 running on the client computer, which allows the client web server to register as a client of the testing service. The testing service 1206 includes one or more databases 1208 and 1210 that store information used to construct library and key files that are downloaded to client web servers, store statistics collected during testing, and store various different data objects and records that describe clients, tests, test runs, experiments, and other data used to conduct web-site testing. The client web server 1212 serves a number of different web pages described by HTML files 1214 to users, represented by user 1216 who accesses the web pages served by the client-web server through a browser 1218 running on the customer computer 1216. The testing service and client web server additionally include web-server engines, application programs, and other components of servers and computer systems (1215 and 121 in FIG. 12A).

As shown in FIG. 12B, the client carries out a dialog 1220 with the testing service in order to provide the testing service with information about the client that allows the testing service to prepare a client record or records 1222 that describe the client and to store the client record or records in the database. In addition, the testing service may undertake various authorization and authentication steps to ensure that the client web server is a valid web server and that the client can transmit remuneration for testing services to the testing service. As part of client initialization, the testing service prepares a script library 1224 and a key file 1226 that, the testing service downloads to the client web server. The script library 1224 includes routines that are called by client-Web-server users during web-site testing. This library is referred to, as a “script library” because script routines are often provided to browsers for execution. However, other types of routines may be provided by other types of libraries. The key file 1226 includes cryptographic information that, ensures that all information exchanges that occur between client users and the testing service are secure.

As shown in FIG. 12C, following client initialization, the client modifies any of the HTML encodings of web pages that may be altered during testing of the client-web server by the testing service. The alternations are minimal. To each HTML file that encodes a web page that may be tested, the client generally adds only two single-line statements and, in the case that display objects are not associated with identifiers, as discussed above with reference to FIG. 3, the client web server provide identifiers for each of the objects that may be specified as factors for testing of web pages. The single-line statements are generally identical for all client web pages, greatly simplifying the web-page modification carried out by the client. The first statement results in downloading of script library from the client web server, and the second script launches one or more information exchanges between the testing server and user computer. In the case that a conversion event is tied to a specific user-activated display device, such as a button, a call to a conversion script is, inserted into the HTML file, so that user activation of the user-activated display device generates an information-exchange transaction with the testing service corresponding to a conversion event. As discussed above, these may be the HTML identifiers discussed with reference to FIG. 3, or other types of identifiers. In many cases, simple changes to the HTML files can be automatically carried out by a script or by routines provided by a content-management-service application-programming interface.

Following client initialization and modification of the HTML-file encodings of web pages that may be subsequently tested, the client can configure and run tests through a test-configuration interface provided as a website by the testing service to clients, as shown in FIG. 12D. The test configuration interface 1230 allows the client computer to define tests 1232, specify and modify already-specified test runs 1234, and specify segments 1236, and, using client-supplied test and test-run specifications, the testing service generates the experiments 1238 associated with each test run. All of the test, test-run, and segment information is stored in records associated with a reference to the client in one or more databases within the testing service. The test-configuration interface 1230 additionally provides run-time information to the client web server and allows the client web server to launch trial runs and test runs.

When a client web server has created a test and launched a test run for the test, the testing service provides modifications of the tested web page to users of the client-web-server during the test in order that the users receive altered web pages that constitute test experiments, and the testing service collects statistics based on users' access to web pages under test. This process is next described, with reference to FIGS. 12E-G.

When a client-web-server user 1216 accesses a test web page, the client-web-server user sends an HTML-file request through the Internet to the client web server 1212, as shown in FIG. 12E, which returns the requested HTML page to the client-web-server user 1216 for rendering and display by the browser 1218 executing within the user's computer. As the browser begins to process the HTML file, the browser encounters, a statement 1240 that causes the browser 1218 to request the script library from the client web server. When the script library is downloaded by the client web server, the HTML file is modified, on the user computer, to launch an additional information exchange with the testing service to download additional library routines from the testing service. This additional information exchange is carried out only when the web being processed is an active test page, the user computer is a valid test subject for an active jest, and the additional library routines are not already cached in the user computer's browser. Insertion of the library-routine-fetch statement is one of the two modifications to the HTML files corresponding to tested web pages made by the client.

Next, as the browser continues to process the HTML, as shown in FIG. 12F, the browser encounters a call to the library routine “WM.setup” 1241. When executed by the browser, WM.setup initiates one or more information exchanges with the testing service during which the testing service can access cookies and other information associated with the web page on the user's computer, and the user computer receives web-page modifications from the testing service. Cookies can be used, for example, to ensure that a test subject who repeatedly accesses a landing page receives the same experiment, or test page, each time Only when the web page being processed by the user computer is an active test page, and the user computer is an active test subject, are web-page modifications returned to the user computer by the testing service, and information uploaded by the testing service from the user computer. When this web page and user are validated, the testing service records the page accessed by the user, an identifier of the user, and a time of access in one or more database entries 1242 and returns a snippet, representing one or more nodes or sub-trees of the DOM corresponding to the web page, to the user computer, which modifies the DOM constructed by the browser to incorporate the snippet downloaded by the testing service to the user. In other words, the testing service downloads modifications that transform the web page downloaded by the user to a particular altered web page representing an experiment. Thus, following the information transaction illustrated in FIG. 12F, the user's browser alters the DOM and displays, to the user, the altered web page corresponding to an experiment as part of the test run. The snippet is constructed or retried by the testing service based on the orthogonal-array test basis or other test design. The stored test, design defines the experiments, from which the testing service selects experiments for provision to users in order to obtain a well-distributed sampling of experiments during the test.

Subsequently, as shown in FIG. 12G, should the user download a page, or invoke a feature on a page, corresponding to a conversion event, the user's browser, in processing the HTML file, encounters a library call 1250 that results in an information transaction between the user and testing service. The testing service checks to ensure that the web page is a valid conversion page for an active test, that the user is a valid test subject. When all of these tests are valid, the conversion event is recorded 1352 for the experiment by the testing service.

Finally, as shown in FIG. 12H, when the testing service has collected sufficient data to consider the test run to be complete, the testing service changes the status of the test run to complete, and may then undertake analysis, and reporting or the test results. The test results may be automatically returned to the client web server, or may be subsequently returned, on demand, when the client checks the status of the test run and determines that the test run has been completed.

Again, the above-described testing service and web-analysis system is but one example of an environment in which the SDL that represents an embodiment of the present invention may be applied. The SDL is a general segment-definition language and SDL-based subsystems that execute SDL segment definitions can be, included in a number of different types of special-purpose and general computer systems.

### The SDL and SDL Implementation

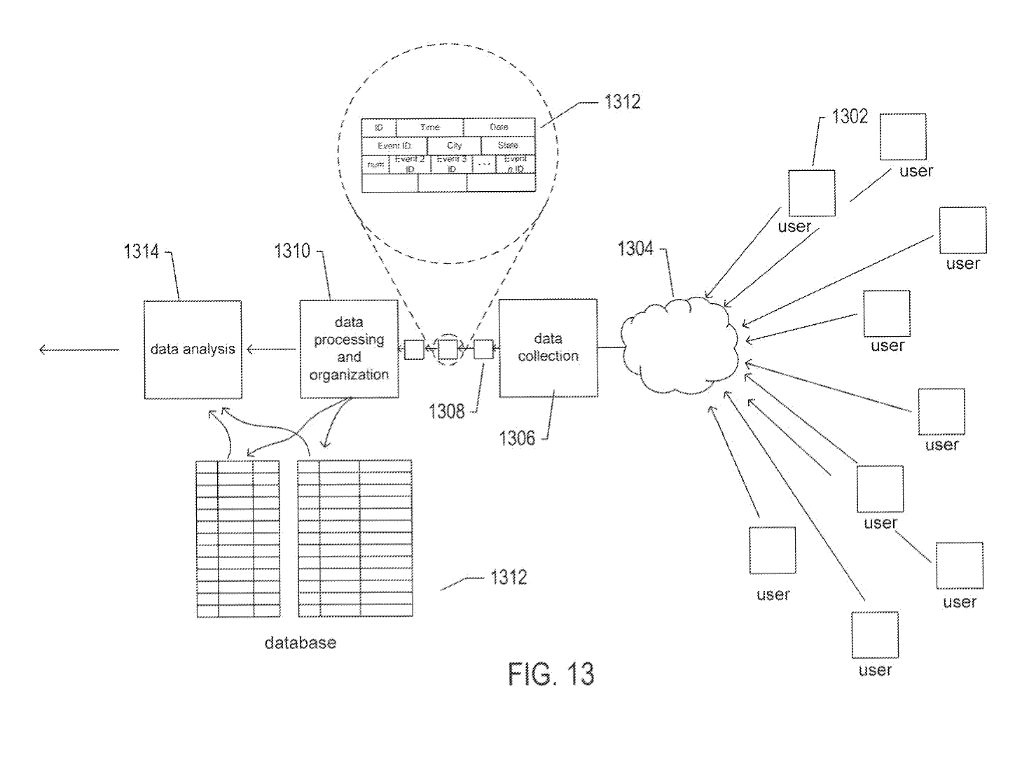

FIG. 13 provides an abstract illustration of data input and data processing within a web-analysis system. As discussed above, in the previous subsection, a web-analysis system receives data from multiple users, such as user 1302, when users interact with instrumented web pages. The data is transmitted via the Internet and/or various other communications media 1304 to a data-collection component of the web-analysis system 1306. The data-collection component includes hardware communications components, operating-system components that provide an interface between higher-level applications and routines and the hardware communications components, and web-analysis-system routines that process information received from the users into formatted raw data 1308 that is output by the data-collection component to a data-processing-and-organization component 1310. The data-collection component may, in certain implementations, output data records 1312 that contain various fields that specify attribute values which characterize and define input received from users. As one example, completion by a user of an Internet-based retail transaction may result in production, by the data-collection component, of a retail-transaction record that includes attributes that identify the user, the time and date of the transaction, and other information relevant to the transaction. The data-processing-and-organization component 1310 receives the data records from the data-collection component and stores them within a web-analysis-system database 1312. There are many different types of databases and methods for organizing data within databases. As one example, the web-analysis-system may employ a relational, database system that stores processed data into various relational tables that are defined and organized according to a relational database schema to minimize redundant, storage of data and maximize the efficiency and flexibility by which various different types of queries can be executed with respect to the database in order to extract information useful to data-analysis programs. A data-analysis component of the web-analysis system 1314 accesses information stored in the database in order to analyze information collected from users and to produce analytical results, such as indications of optimal web-page design, statistical metrics with respect to effectiveness of various marketing strategies, statistical information with respect to web-page-based transactions, and other such information.

There are many different possible variations with respect to the data-input pattern illustrated in FIG. 13. For example, the data-collection component 1306 may transfer formatted data records directly to data-analysis programs within the data-analysis component 1314 in order to facilitate real-time data-analysis tasks. Furthermore, in addition to data analysis, downstream programs may employ information stored in the database 1312 or even real-time data in order to carry out a variety of tasks in, addition to analytical tasks. For example, automated email-sending programs, including programs in remote client computers to which processed data may be transmitted, may employ user information to direct information or requests back to users, including to particular categories of users identified by values or ranges, of values of attributes associated with the users.

As mentioned above, various types of Internet-based retailing transactions and other web-based activities are often based on a concept of market segments. Market segments are a subset of a more general concept of segments. Considering a total set users who interact with a particular instrumented web page or set of web pages during the time course of a web-page-based marketing experiment or other research endeavor, segments are well-defined subsets of the total set of users. Segments are generally defined as the subset of users associated with attributes that fall within specified attribute-value ranges. For example, those users who, by interacting with an instrumented web page, generate input data, to the web-analysis system and who live in New York City, who are male, between the ages of 18 and 35, and who have incomes greater than $50,000 per year may represent a particular segment, perhaps, as one example, a potentially motorcycle-friendly segment to which motorcycle advertisements might be effectively targeted. Specifying segments, collecting data relative to segments, and extracting data from databases relative to segments represents a frequently encountered task in web-analysis systems and other systems that receive and process data from instrumented web pages and from other marketing and research experiments.

FIGS. 14A-B illustrate several types of segment-based data operations commonly encountered in a web-analysis system. FIGS. 14A-B use illustration, conventions used above in FIG. 13. In a first example, shown in FIG. 14A, the data-collection component of the web-analysis system 1306 may wish to impose a raw-data filter 1308 in order to filter an input stream of raw data 1402 to reject input, raw data 1404 that is not associated with a particular segment of interest and to accept only raw data 1406 that is relevant to a particular segment of interest. As a second example, shown in FIG. 14B, an analytical program in the data-analysis component 1314 may wish to extract, from the database 1312, only particular data related to a segment of interest, the particular data related to the segment of interest shown as cross-hatched rows 1410-1415 in FIG. 14B. These are merely two of many different possible applications of the concept of segments to Operations carried out within a web-analysis system and related systems, including client systems that receive analytical results and processed data from a web-analysis system and various types of information-providing and service-providing systems.

As discussed above, it would be possible for web-analysis programmers and developers of other types of programs and routines who employ segments to define and instantiate segments by using database query languages, such as SQL, as well as detailed knowledge of the contents and organization of processed data within databases associated with a web-analysis system or by writing data-processing programs to carry out segment-based processing of input raw data. However, such ad hoc methods are costly, time-consuming to develop, extremely error prone, and tightly tied to, and constrained by, a particular database or raw-data delivery-and-formatting components of a particular web-analysis system. Recognizing these drawback and inefficiencies, the currently described segment description language (“SDL”) was conceived and developed in order to provide a straightforward, simple-to-use, database-and-platform-independent, and cost-effective method for specifying segments during analytics-program development and development of other segment-based programs and routines. In addition, interactive SDL was conceived and developed to provide, through a user interface, a real-time interactive system to allow users to specify and view segments relative to any of various data sources.

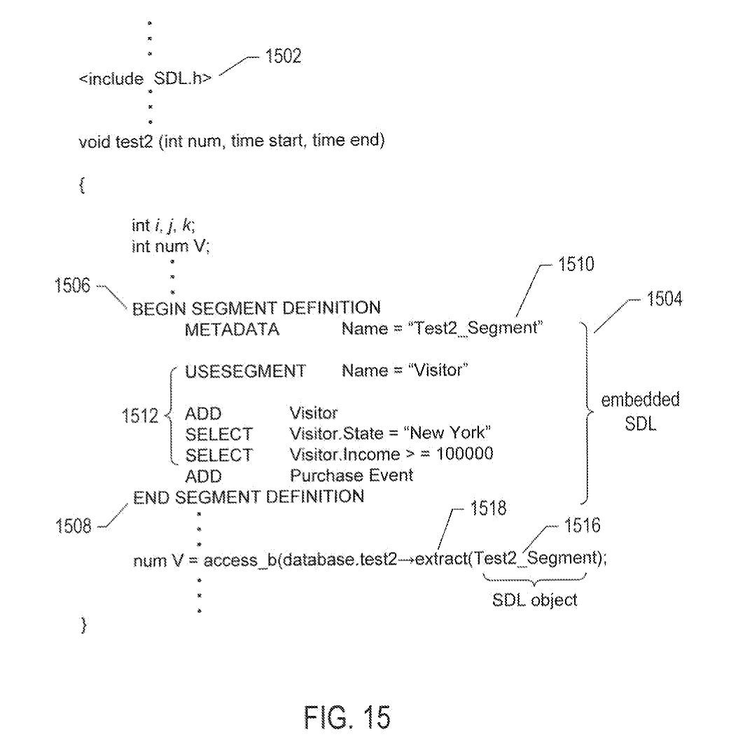

FIG. 15 provides an example of embedded SDL according to one embodiment of the present invention. FIG. 15 shows a small portion of a web-analysis program that includes an embedded SDL segment definition. In order to employ embedded SDL, SDL libraries are included into the program via some type of library-inclusion statement executed by a preprocessor 1502. The web-analysis program may be written in any of numerous programming languages, such as Java, C++, Ruby, and other such languages. At the point in the program at which a particular segment needs to be specified, the programmer can employ embedded SDL statements 1504 in order to specify the particular segment. The segment definition begins with a “BEGIN SEGMENT DEFINITION” statement 1506 and ends with an “END SEGMENT DEFINITION” 1508. A METADATA statement specifies the name associated with the segment 1510, in this case “Test2_Segment.” Additional statements 1512 define the segment to be those users who live in New York State, who have incomes greater than $100,000, and who purchased one or more items from an instrumented web page during a marketing experiment from which data was collected. The defined segment is an SDL object associated with a name. That name can be supplied as an argument to various routines and methods, such as argument 1516, to specify a set of visitor data objects that represent visitors or users within a well-defined segment. For example, in the program portion shown in FIG. 15, an extract method 1518 receives an SDL object and uses the SDL object to extract data from a database related to the segment defined by the SDL object.

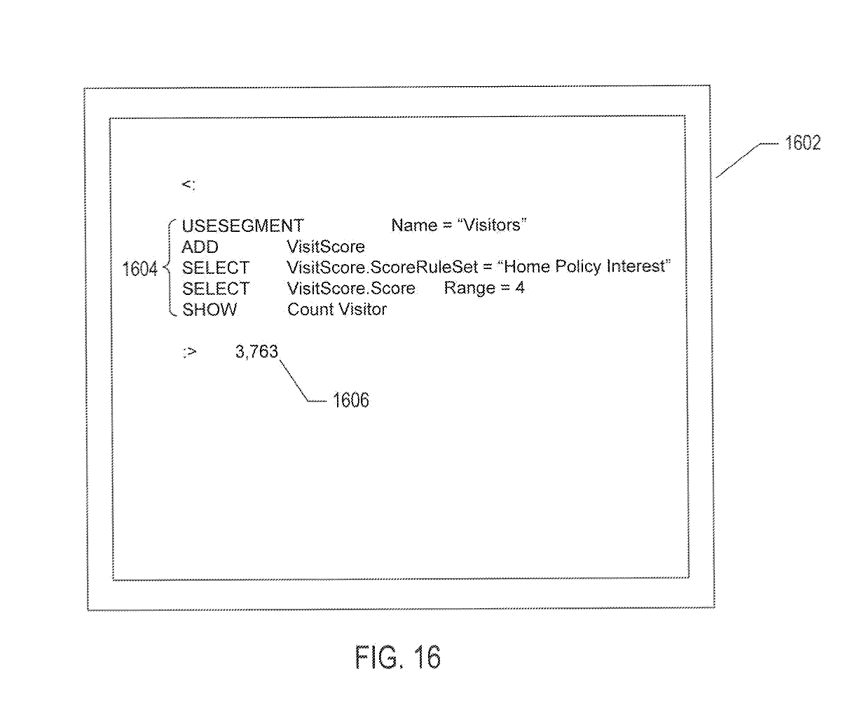

FIG. 16 illustrates interactive SDL, which represents one embodiment of the present invention. Interactive SDL statements are generally input, by a user, via a user interface 1602 to an SDL interpreter which executes interactive, SDL statements to produce results displayed to the user through the user interface. In the example shown in FIG. 16, a user has input a set of related. SDL statements 1604 into the user interface which have been interpreted by the interpreter and executed against a particular database in order to produce a desired output 1606. Thus, interpreted SDL and interpreted-SDL user interfaces allow users to experiment with SDL segment definitions in real time and to use interpretive SDL as a type of high-level query language. As one example, a web-analysis program developer may wish to experiment with SDL definitions, using an interpreted-SDL user interface, prior to embedding a segment definition into a web-analysis program. As another example, a client of a web-analysis service may be provided an interpreted-SDL user interface in order to explore, in real time, various different market segments with respect to data collected during a marketing experiment by a web-analysis system on behalf of the client.

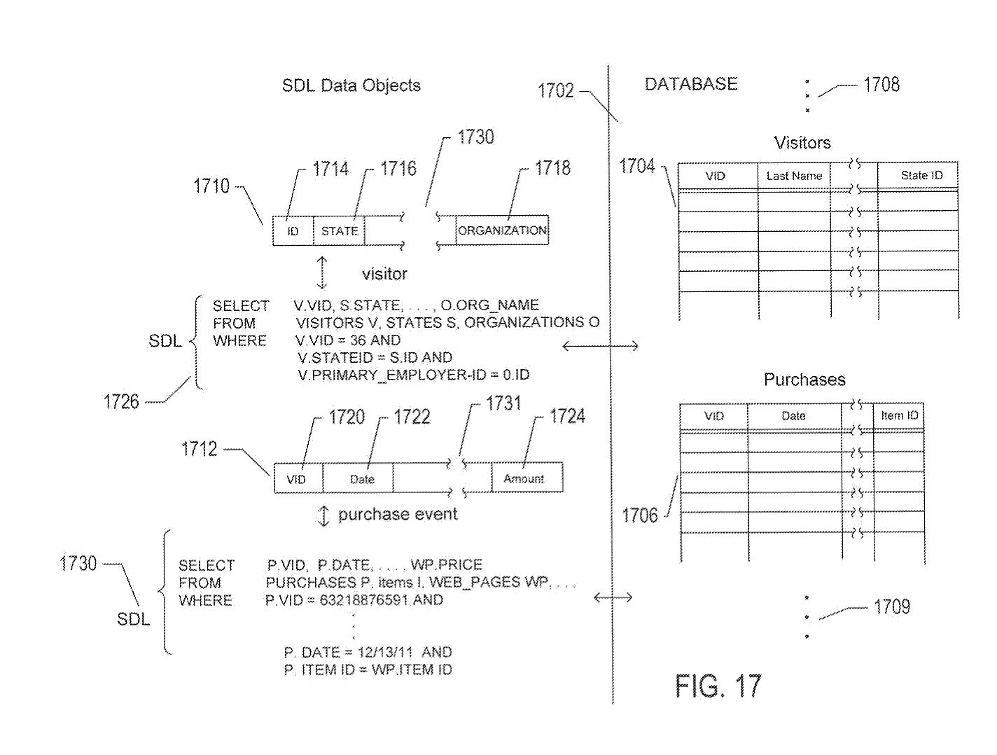

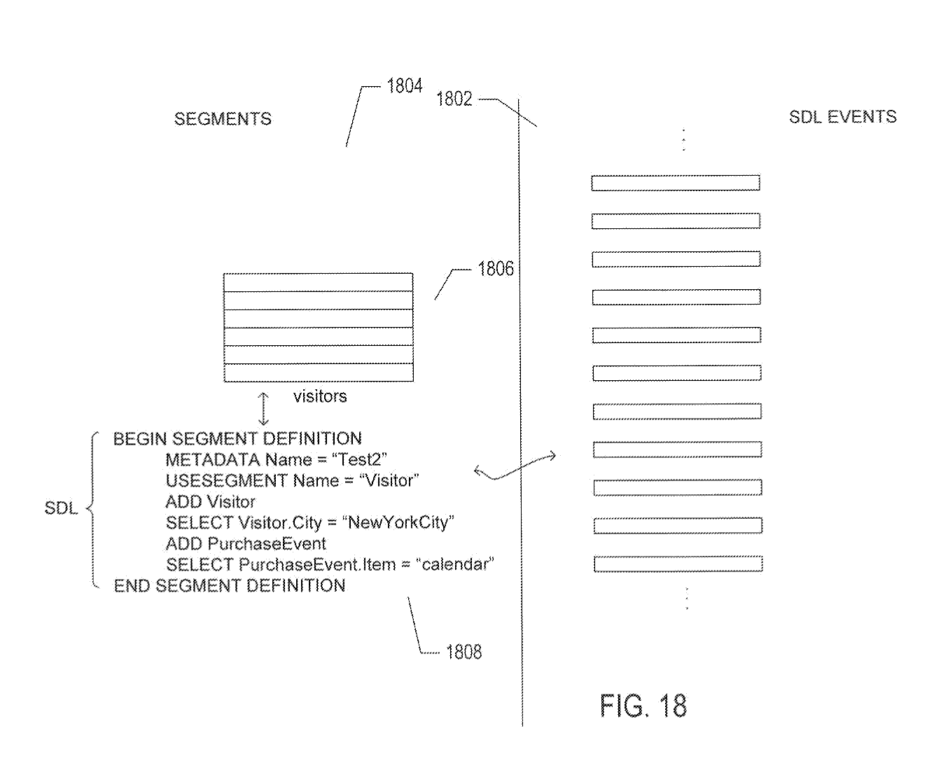

FIGS. 17 and 18 illustrate conceptual features of SDL, which represent one embodiment of the present invention. FIGS. 17-18 show three different hierarchically ordered data levels related to segments and SDL objects. The first data level is the processed data stored within a database, shown in the right-hand portion 1702 of FIG. 17. As discussed above, the database may be a relational database in which data is organized into a number of relational-database tables, such as the visitors table 1704 and purchases table 1706 shown in FIG. 17. The ellipses 1708-1709 in the right-hand portion of FIG. 17 indicate that the database contains additional tables. By contrast, SDL is concerned with two basic types of data objects: (1) visitor data objects; and (2) event data objects. Visitor data objects represent users who interact with an instrumented web page during a marketing experiment, research endeavor, or usage monitoring resulting in transmission of raw data to a web-analysis system or other analytical system. Event data objects represent arbitrarily defined events that occur during the marketing experiment, research endeavor, or usage monitoring. For example, the fact that a particular user inputs a mouse click to a purchase button to complete an Internet-based retail transaction may be defined as a purchase event. In the left-hand portion of FIG. 17, which represents the lowest-level data objects with which SDL is concerned, a visitor data object 1710 and an event data object 1712 are represented as objects comprising a set of attribute values. For example, a visitor object may include an identifier of a user 1714, an indication of the state of residence of a user 1716, and the name of an organization that employs the user 1718. Similarly, an event may include the ID of a user associated with the event 1720, a date on which the event occurred 1722, and event-type-specific information, such as a purchase amount 1724. The broken lines 1730-1731 in these representations indicate that both visitor data objects and event data objects may include an arbitrary number of different attributes.

As discussed above, the low-level SDL data objects may be derived from data stored within the database. However, the derivation is often non-trivial and it may be, in many cases, relatively complex. In the case that the raw or processed data is stored in a relational database, low-level-SDL data objects may be defined by SQL statements. For example, visitor object 1710 is defined by SQL statement 1726 which carries out a multi-way join among a number of relational database tables and extracts relevant information from these joined tables as attribute values for the visitor data object. Similarly, SQL statement 1730 maps attribute values within the event data object 1712 to data stored within relational database tables within the relational database. Of course, the mapping, between low-level SDL data objects and data stored within the database shown in FIG. 17 is but one example of many possible mappings and many different types of databases organized in different fashions as well as raw-data streams and processed-data streams. The database-independent and data-independent characteristics of SDL segment definitions derive, in part, from the abstraction of data stored in or obtained from many different types of data sources to well-defined, low-level SDL data objects. The web-analysis program developer or user of an interactive-SDL user interface does not need to know the type of underlying data source, organization and formatting of data within the underlying data source, or the methods by which data can be accessed and extracted from various types of data sources, but needs only to understand the relatively straightforward concept of SDL visitor data objects and SDL event data objects.

The right-hand portion of FIG. 18 1802 illustrates the space of low-level SDL data objects that represent a data-source-independent abstraction of one or more underlying data sources, as discussed above with reference to FIG. 17. The left-hand portion of FIG. 18 1804 illustrates segments defined by SDL segment definitions. A segment is a set of one or more visitor data objects 1806. These visitor data objects are collected from the space of SDL low-level data objects shown in the right-hand side of FIG. 18. SDL segment definitions, such as SDL segment definition 1808, provide a recipe or menu for extracting low-level visitor data objects from the SDL data-object space 1802. Thus, SDL is directed to specifying sets of one or more visitors, or users, who have interacted with instrumented web pages during a marketing experiment, research endeavor, or usage monitoring in ways that result in transmission of data to a web-analysis system. SDL segment definitions, such as the SDL segment definition 1808 shown in FIG. 18, can specify attribute values, ranges of attribute values, events, and attribute values or ranges of attribute values associated with events as criteria for selecting particular visitor data objects for inclusion into a segment from the entire space of low-level SDL data objects associated with a particular data-collection activity. Even from the simple examples shown in FIGS. 17-18, it can be appreciated that translation of a relatively simple segment definition 1808 into one or more SQL-implemented queries to extract information from a relational database may be an exceedingly difficult and time-consuming task. Moreover, as discussed above, any such particular translation would be very closely tied to a particular data source, including to the type of data source, the organization of data within the data source, the formatting of data, particular data types, and other such details. By contrast, the SDL statement 1808 is a general description of a segment that can be used, by an SDL-based subsystem, discussed below, to extract a set of visitor objects corresponding to the segment from an arbitrary set of one or more data objects. The SDL-based subsystem, rather than a programmer or user, maintains the data-source-specific and data-source-access-methods-specific information needed to translate segment definitions into queries and/or routines that extract information from data sources and assemble the extracted information into visitor data objects that together compose a segment.

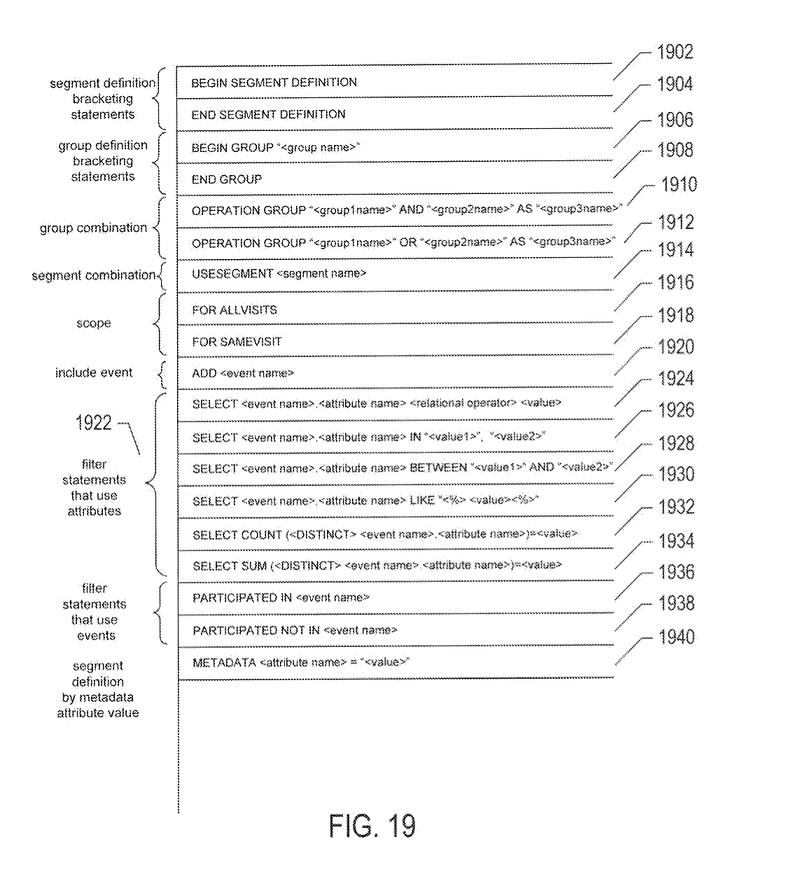

FIG. 19 provides a table of a number of SDL statement types according to one embodiment of the present invention. Particular versions of SDL may include different or additional statements. The statements shown in FIG. 19 represent one embodiment of an SDL that provides a useful segment-specification facility in various example web-analysis systems. As discussed above. SDL segment definitions are bracketed by a “BEGIN SEGMENT DEFINITION” statement 1902 and an “END SEGMENT DEFINITION” statement 1904. Segment definitions may include definitions of groups, each of which is similarly bracketed by a “BEGIN GROUP” statement 1906 and an “END GROUP” statement 1908. In FIG. 19, variable portions of statements are shown within angle brackets. For example, the “BEGIN GROUP” statement includes a group-name; argument enclosed within quotes, where the group-name argument is a character string that is associated with the group as a name of the groups. Groups may be combined by set intersection 1910 and set union 1912 operations. For example, a third group can be created by combining the members of two already-defined groups by the union operation 1912. Segment definitions can also be combined in hierarchical fashion. The “USESEGMENT” 1914 can be included in the definition of a new segment, and has the effect of importing a previously defined segment into the new segment. Two scoping statements 1916 and 1918 describe the scope for importing events into segment definitions. Events can be generally imported, regardless of whether the events occurred over multiple visits by visitors or during a single visit, corresponding to the scoping rule embodied in the “FOR ALLVISITS” statement 1916, or events may be imported together only when they occurred during a single visit of an instrumented web page by a particular visitor, as represented by the “FOR SAMEVISIT” scoping statement 1918. For example, one could import a purchase event and a navigation-from-a-known-web-page event into a segment definition. In the case of “FOR ALLVISITS” scoping, any visitor that, at any time during an experiment navigated from a particular web page to the instrumented web page and executed a purchase from the instrumented web page may be included in the segment definition. By contrast, under the “FOR SAMEVISIT” scoping, only those visitors that in a single visit, navigated from the particular web page and executed a purchase would be included in the segment. Events are imported or added into a segment definition by an “ADD” statement 1920. Visitor objects may be, filtered for inclusion into a segment based on a variety of different types of “SELECT” statements 1922. Perhaps the most straightforward SELECT statement is the first SELECT statement 1924 shown in FIG. 19, which selects visitors associated with events having an attribute with a value related to a value supplied as an argument by one of the familiar relational operators, including =, >, <, ≦, ≧, and !=. SELECT statements that select visitors associated with an event having an attribute within a range of values, inclusive of the values 1926 and exclusive of the values 1928 can also be used. A fuzzy comparison or matching using the “like” operator is also possible 1930. SELECT statements may incorporate aggregation operators, including COUNT 1932 and SUM 1934. A “PARTICIPATED IN” statement 1936 and a “PARTICIPATED NOT IN” statement 1938 allow visitors to be selected based on associations or lack of associations with a particular type of event, respectively. Finally, a variety of different metadata attributes associated with segments can be specified using the “METADATA” statement 1940. Metadata attributes associated with segment definitions may include the name of a segment specified by the segment definition, a textural description of the segment definition, and a variety of different parameters that specify one or more data sources or subsets of data within one or more data sources in which visitor objects are to be extracted. For example, metadata attributes may specify that visitor objects are to be extracted from data collected in a particular time period on a particular date or over a particular range of dates, or provided by one or more specified marketing experiments or other research endeavors, and other such parameters.

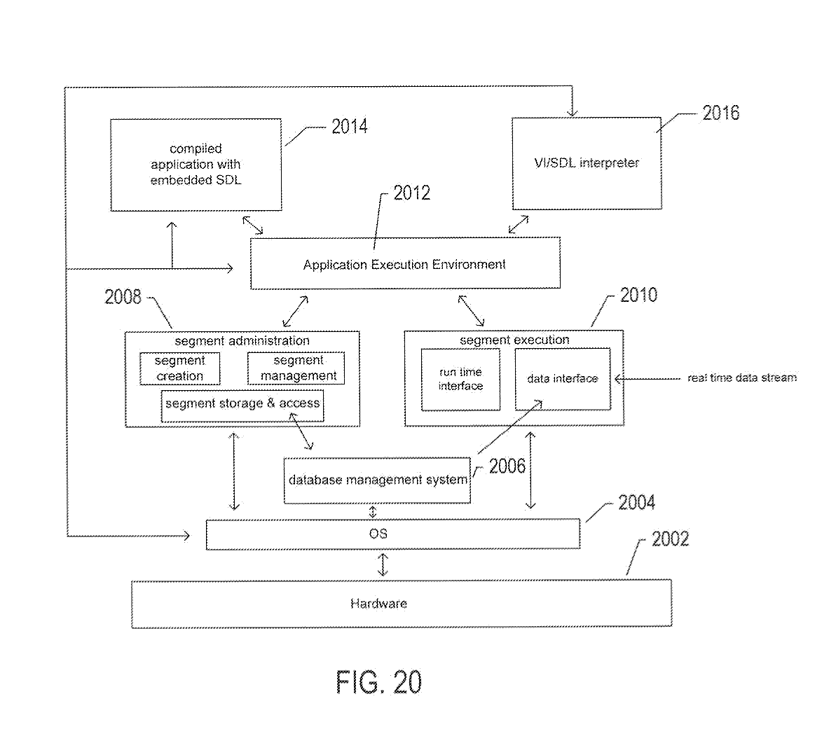

FIG. 20 illustrates the components of a web-analysis system or other computer system that implement SDL according to one embodiment of the present invention. The web-analysis system or computer system generally includes a hardware layer 2002 representing, the physical computer hardware in one or more computer systems. Each computer system generally features an operating system 2004 that executes on the computer hardware to provide a program execution environment for application programs that execute on the computer system. A database-management system 2006 is an application program that provides a data-storage and data-access interface to other application programs. Examples include various relational database-management systems provided by various relational-database-management-system vendors. SDL is implemented by a segment-administration component 2008 and a segment-execution component 2010. Both the segment-administration and segment-execution components are implemented by computer instructions, stored within the computer system on a computer-readable medium, such as in electronic memory or on mass storage devices, to control the computer system to provide SDL functionality to various different types of application programs executing with the computer system. The segment-administration and segment-execution components together implement functionality provided to application programs through an application-execution-environment 2012, which is an application program interface (“API”) for SDL. As discussed above, the application execution environment can be accessed by executing the application program compiled from source code with embedded SDL 2014 or may be accessed by an interpretive-SDL user interface application program 2016.

It should be emphasized that an SDL subsystem within a computer system is a tangible, physical component of the computer system comprising computer instructions that are stored within a computer-readable, medium, including electronic memory and/or mass-storage devices, for execution on one or more processors within the computer system to control the computer system to provide SDL functionality. SDL subcomponents of web-analysis systems and other computer systems extract data and move data from mass-storage devices to electronic memory and among different electronic memories within the web-analysis system or other computer system, and therefore necessarily effect tangible physical transformations of hardware components within the web-analysis system or other computer system.

The segment-administration component 2008 provides for creation, storage, access, and management of segment definitions. Segment definitions, in one embodiment of the present invention, are stored in a database-management system for subsequent access and use, for example. A segment-administration component includes SDL compilation and interpretation functionality that translates SDL segment definitions into database queries and/or routines that access data sources, including databases and raw or processed input-data streams to extract desired visitor objects.

As discussed above, the segments defined by SDL segment definitions are execution by the segment-execution component of an SDL subsystem to produce sets of visitor objects that represent subsets of the total visitors who over some defined period of time. When an SDL definition is executed, the visitor objects corresponding to the segment definition are, composed from data extracted from one or more data sources for automated input to application programs, interpreted-SDL user interfaces, and other programs and routines that employ the visitor objects for various different purposes. These purposes may include accessing and/or collecting additional information relative to the visitor objects in order to carry out marketing analyses and other types of analyses, directing various types of information to users or user devices corresponding to the visitor objects, collecting further information from users or user devices corresponding to the visitor objects, and for carrying out many additional types of tasks. The mechanics of visitor-data-object return by the SDL-subsystem execution component to requesting application programs may be implemented similar to implementations of the return of relation-database tuples by embedded SQL in procedural programming languages. The visitor-data objects may be returned one-at-a-time, in blocks, or all-at-once in one or more memory buffers. The memory buffers may be shared between the SDL subsystem and an application program that receives visitor data objects corresponding to a segment definition, or may be allocated by either the SDL subsystem or the application program and references to the memory buffers passed to the non-allocating party. Many additional mechanisms by which data is transferred between concurrently or simultaneously executing programs can be used.

In summary, the segment-administration component, according to one implementation of the present invention, provides functionality for storing, accessing, managing, and transforming SDL segment definitions into queries, routines, and other executable representations that can be executed, by the segment-execution component of an SDL subsystem, to retrieve, data from one or more data sources and assemble the retrieved data into complete or partial visitor data objects that are returned, by any of various data-transfer mechanisms, to requesting, application programs. Data sources may be databases, files, or various types of real-time or buffered data streams. The SDL subsystem thus provides the physical mechanism by which segment definitions, referenced from application programs, are transformed into sets of visitor-data objects stored in electronic memory that can be used by application programs for many different purposes.

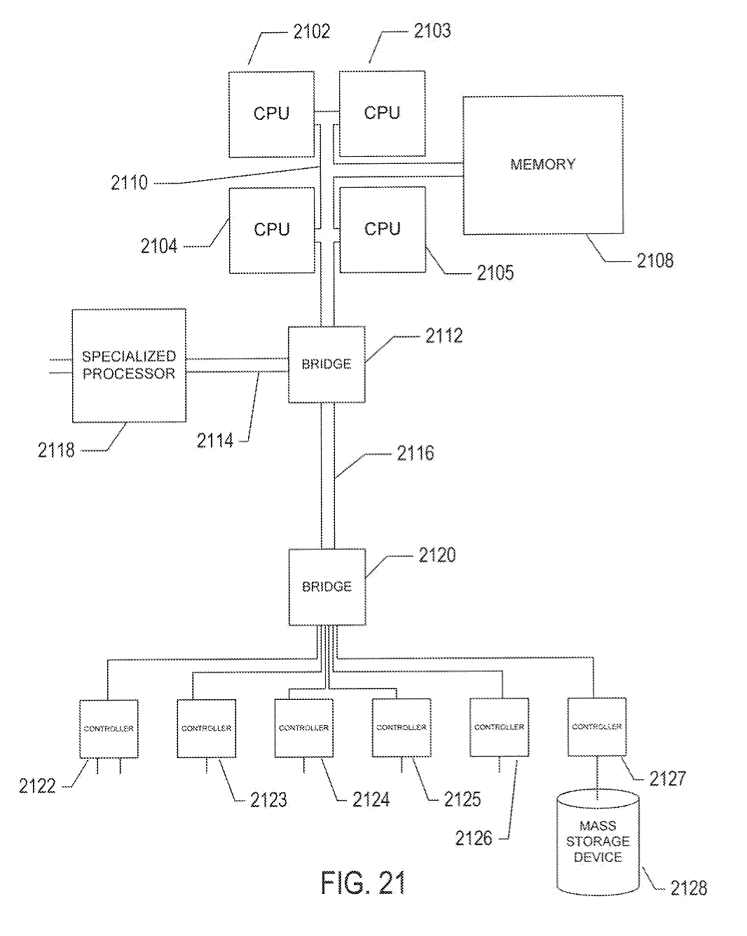

FIG. 21 illustrates a generalized computer architecture for a computer system that, when controlled by segment-subsystem component programs to generate and execute segment definitions, represents one example of the present invention. The computer system contains one or multiple central processing units (“CPUs”) 2102-2105, one or more electronic memories 2108 interconnected with the CPUs by a CPU/memory-subsystem bus 2110 or multiple busses, a first bridge 2112 that interconnects the CPU/memory-subsystem bus 2110 with additional busses 2114 and 2116, or other types of high-speed, interconnection media, including multiple, high-speed serial interconnects. These busses or serial interconnections, in turn, connect the CPUs and memory with specialized processors, such as a graphics processor 2118, and with one or more additional bridges 2120, which are interconnected with high-speed serial links or with multiple controllers 2122-2127, such as controller 2127, that provide access to various different types of mass-storage devices 2128, electronic displays, input devices, and other such components, subcomponents, and computational resources. Examples of the present invention may also be implemented on distributed computer systems and can also be implemented partially in hardware logic circuitry.

### First Example Interactive SOL Session

The first example interactive SDL session illustrates how a user may, in real time, through an interactive-SDL user interface, explore how various SDL statements affect and constrain a segment definition.

In an initial step, a user may import all of the visitors associated with one or more data sources using a “USESEGMENT” statement and an “ADD” statement to add all of the visitor data objects. The “SHOW COUNT” statement returns a count of all of the visitors associated with the one or more data sources as well as a handle that represents the segment defined by this initial set of SDL statements. In this example, the handle is named “H1.”

USESEGMENT Name=“Visitor”
ADD Visitor
SELECT Visitor.City
SHOW COUNT

In the next step, the user may further constrain the interactive segment definition by supplying a particular city and gender for visitors to be included in the segment:

USEHANDLE Name=“H1”
SELECT Visitor.City = “XXXX”
SELECT Visitor.Gender = “Male”
SHOW COUNT

The count shown as a result of the second statement, which returns a new handle “H2,” would presumably be significantly smaller than the count returned in the first step, unless all of the visitors associated with one or more data sources resided in the specified city and were male.

In a third step, the user may qualify the segment definition, interactively, by importing several different types of events into the definition, one of the events being visitors who purchased at least $100 of items from instrumented web pages in the course of the marketing experiment or other research endeavor.

USEHANDLE Name=“H2”
FOR ALLVISITS
ADD ContentGroupEvent
SELECT ContentGroupEvent.ContentGroup = “XXXX”
ADD PurchaseEvent
SELECT PurchaseEvent.Revenue >= 100
SHOW COUNT

In the case that the user is happy with the segment defined in the preceding steps, associated with the handle “H3” returned in the third step, the user may wish to save this segment under the name “Segment1” as follows:

USEHANDLE Name= “H3”
BEGIN SAVEAS SEGMENT

METADATA Name = “Segment1
METADATA Description = “asdf”
METADATA CreateDate = “1/1/10 12:00am”

END SAVEAS SEGMENT

Alternatively, the segment created in the above four steps can be created using a single, segment definition as follows:

BEGIN SEGMENT DEFINITION

METADATA Name = “Segment1”
METADATA Description = “asdf”
METADATA ...
USESEGMENT Name=“Visitor”
ADD Visitor
SELECT Visitor.City = “XXXX”
SELECT Visitor.Gender = “Male”
FOR ALLVISITS
ADD ContentGroupEvent
SELECT ContentGroupEvent.ContentGroup = “XXXX”
ADD PurchaseEvent
SELECT PurchaseEvent.Revenue >= 100

END SEGMENT DEFINITION

Finally, an example of a definition of a segment that includes definitions of four different groups is provided:

BEGIN SEGMENT DEFINITION

METADATA Name = “SegmentWithGroups”
METADATA Description = “asdf”
METADATA CreateDate = “1/1/10 12:00am”
USESEGMENT Name=“Visitor”
BEGIN GROUP “G1”

ADD Visitor
SELECT Visitor.City = “XXXX”
SELECT Visitor.Gender = “Male”

END GROUP
BEGIN GROUP “G2”

FOR ALLVISITS
ADD ContentGroupEvent
SELECT ContentGroupEvent.ContentGroup = “XXXX”
ADD PurchaseEvent
SELECT PurchaseEvent.Revenue >= 100

END GROUP
OPERATION GROUP “G1” OR GROUP “G2” AS GROUP “G3”
BEGIN GROUP “G4”

ADD SearchEvent
SELECT SearchEvent.SearchEngine = “Google”

END GROUP
OPERATION GROUP “G3” AND “G4”

END SEGMENT DEFINITION

The above segment definition, entitled “SegmentWithGroups,” is similar to the above-created segment definition “Segment1,” with the additional qualification that visitors in the segment “SegmentWithGroups” need to have carried out a Google search in addition to other criteria specified for “Segment1.”

### Second Interactive SDL Session

In this, second interactive-SDL-session example, a marketing manager for a travel company carries out a number of segment-related tasks, defining segments in order to facilitate execution of the tasks. For the first task, because hotel sales have decreased and the marketing manager needs to attempt to increase revenue for hotel sales, the marketing manager wants to send direct email to three different test markets to determine whether or not direct email will drive additional hotel sales. The following segment definition defines a segment of visitors who responded to a previous marketing campaign but did not purchase a hotel stay:

BEGIN SEGMENT DEFINITION

METADATA Name = ″A.01″
METADATA Description = ″asdf″
METADATA ...
USESEGMENT Name = ″Visitor″
FOR ALLVISITS
ADD AdClickthroughEvent
SELECT AdClickthroughEvent.CampaignName =
“XXXX”
SELECT AdClickthroughEvent.AdClickthroughEventTime
BETWEEN

“X/X/X” AND “Y/Y/Y”

PARTICIPATED NOT IN HotelPurchaseEvent
SELECT HotelPurchaseEvent.HotelPurchaseEventTime
BETWEEN

“X/X/X” AND “Y/Y/Y”
END SEGMENT DEFINITION

Next, the marketing manager determines that sales of flights to Amsterdam are less than normal for an upcoming period of time. The marketing manager therefore desires to identify a segment of visitors who did, not purchase a flight to Amsterdam during the last seven days, but that expressed interest in purchasing a flight to Amsterdam via interaction with instrumented web pages:

USESEGMENT Name = ″Visitor″
ADD ProductViewEvent
SELECT ProductViewEvent.Destination TOP 10 DESC
SELECT ProductViewEvent.ProductViewEventTime BETWEEN
“X/X/X” AND “Y/Y/Y”
SHOW COUNT Visit, Visitor, Event
USEHANDLE Name=”H1”
PARTICIPATED NOT IN PurchaseEvent
SELECT PurchaseEvent.Destination = “Amsterdam”
SELECT PurchaseEvent.PurchaseEventTime BETWEEN “X/X/X”
AND “Y/Y/Y”
SHOW COUNT

Having interactively explored segment definition and happy with the result, the marketing manager creates a named segment for storage by the SDL segment-administration component and export to an email-application program:

BEGIN SEGMENT DEFINITION

METADATA Name = ″A.03″
METADATA Description = ″asdf″
METADATA ...
USESEGMENT Name = ″Visitor″
FOR ALLVISITS
ADD ProductViewEvent
SELECT ProductViewEvent.Destination = “Amsterdam”
SELECT ProductViewEvent.ProductViewEventTime BETWEEN

“X/X/X” AND “X/X/X”

PARTIPCATED NOT IN PurchaseEvent
SELECT PurchaseEvent.Destination = “Amsterdam”
SELECT PurchaseEvent.PurchaseEventTime BETWEEN “X/X/X”

AND “X/X/X”
END SEGMENT DEFINITION

Subsequently, the marketing manager may decide to email those contacted in the previous direct-email campaign who did not purchase flights to Amsterdam and remind them that the current promotion of Amsterdam flights will soon end. To this end, the marketing manager defines the following segment:

BEGIN SEGMENT DEFINITION

METADATA Name = ″A.04″
METADATA Description = ″asdf″
METADATA ...
USESEGMENT Name = ″Visitor″
FOR ALLVISITS
ADD AdClickthroughEvent
SELECT AdClickthroughEvent.CampaignName = “XXXX”
PARTICIPATED NOT IN PurchaseEvent

END SEGMENT DEFINITION

As part of offering promotions on flights originating from London, the marketing manager may define a segment corresponding to frequent travelers from London whose home airport is London Heathrow or London Gatwick, who have gold membership status, and who have purchased three or more flights in the past 12 months:

BEGIN SEGMENT DEFINITION

METADATA Name = ″A.05″
METADATA Description = ″asdf″
METADATA ...
USESEGMENT Name = ″Visitor″
FOR ALLVISITS
SELECT Visitor.HomeAirport IN (“LHR”, ”LGW”)
SELECT Visitor.MembershipStatus = “Gold”
ADD PurchaseEvent
SELECT COUNT(EVENT) >= 3
SELECT PurchaseEvent.PurchaseEventTime BETWEEN “X/X/X”

AND “X/X/X”
END SEGMENT DEFINITION

The following segment definition may be used to create a segment of visitors who viewed one or more auto-policy products and began a “request a quote” process but did not complete the process within the last 30 days:

BEGIN SEGMENT DEFINITION

METADATA Name = ″B.01″
METADATA Description = ″asdf″
METADATA ...
USESEGMENT Name = ″Visitor″
FOR ALLVISITS
ADD ProductViewEvent
SELECT ProductViewEvent.ProductType = “Auto Policy”
SELECT ProductViewEvent. ProductViewEventTime BETWEEN

“X/X/X” AND “Y/Y/Y”

PARTICIPATE NOT IN CompleteQuoteEvent
SELECT CompleteQuoteEvent.ProductType = “Auto Policy”
SELECT CompleteQuoteEvent.CompleteQuoteEventTime

BETWEEN “X/X/X” AND “Y/Y/Y”
END SEGMENT DEFINITION

Two additional examples of segment definitions related to insurance policies, created via interactive SDL exploration, are next provided:

USESEGMENT Name = “Visitors”
ADD VisitScore
SELECT VisitScore.ScoreRuleSet = “Home Policy Interest”
SELECT VisitScore.Score RANGES=4
SHOW COUNT Visitor, Visit, Event
================================
BEGIN SEGMENT DEFINITION

METADATA Name = ″B.01″
METADATA Description = ″asdf″
METADATA ...
USESEGMENT Name = ″Visitor″
FOR ALLVISITS
ADD VisitScore
SELECT VisitScore.ScoreRuleSet = “Home Policy Interest”
SELECT VisitScore.Score BETWEEN X AND Y

END SEGMENT DEFINITION
USESEGMENT Name = ″Visitor″
SELECT Visitor.Age >= 45
ADD ProductViewEvent
SELECT ProductViewEvent.ProductType = “Home Policy”
SELECT ProductViewEvent. ProductViewEventTime BETWEEN
“X/X/X” AND “Y/Y/Y”
SHOW COUNT
USEHANDLE Name = “H1”
BEGIN SAVEAS GROUP

METADATA Name = “G1”

END SAVEAS GROUP
ADD ProductViewEvent
SELECT ProductViewEvent.ProductType = “Auto Policy”
SELECT ProductViewEvent. ProductViewEventTime BETWEEN
“X/X/X” AND “Y/Y/Y”
SHOW COUNT
USEHANDLE Name = “H2”
BEGIN SAVEAS GROUP

METADATA Name = “G2”

END SAVEAS GROUP

Although the present invention has been described in terms of particular embodiments, it is not intended that the invention be limited to these embodiments. Modifications will be apparent to those skilled in the art. For example, segment definition and segment execution/population engines can be implemented in many different ways by varying any one or more of development and implementation parameters, including programming language, operating system, modular organization, control structures, data structures, and other such parameters. The foregoing description, for purposes of explanation, used specific nomenclature to provide a thorough understanding of the invention. However, it will be apparent to one skilled in the art that the specific details are, not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A segment-definition-language based segment subsystem of a computer system, the segment-definition-language based segment subsystem comprising:
a segment-administration component that
receives segment descriptions encoded in the segment-definition language from executing application programs,
stores segment descriptions encoded in the segment-definition language in one or more of electronic memory, one or more mass-storage devices, and database-management systems,
retrieves segment descriptions encoded in the segment-definition language from one or more of electronic memory, one or more mass-storage devices, and database-management systems,
returns segment descriptions to executing application programs, and
generates, from a segment description encoded in the segment-definition language, one or more queries and/or routines that, when executed, extract visitor data objects from one or more data sources corresponding to the segment defined, by the segment description; and
a segment-execution component that executes one or more queries and/or routines generated by the segment-administration component to retrieve data from one or more data sources and to assemble, from the retrieved data, a set of visitor data objects.
